(19) United States
(12) Patent Application Publication
(10) Pub. No.: US 2026/0359072 A1
(43) Pub. Date: Nov. 12, 2026

(54) METHOD AND APPARATUS FOR EXECUTING SYSTEM FUNCTION

(71) Applicant: SUZHOU METABRAIN INTELLIGENT TECHNOLOGY CO., LTD., Suzhou, Jiangsu (CN)

(72) Inventors: Jiaming YU, Suzhou, Jiangsu (CN); Shengxin LI, Suzhou, Jiangsu (CN); Fei LU, Suzhou, Jiangsu (CN); Chunwei XU, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/469,762

(22) PCT Filed: Aug. 28, 2025
(86) PCT No.: PCT/CN2025/117643

§ 371 Date: Sep. 26, 2025

(30) Foreign Application Priority Data
May 9, 2025 (CN) 202510595767.1

(51) Int. Cl. G06F 9/445; G06F 9/451

(52) U.S. Cl. CPC G06F 9/44505; G06F 9/451

(57) ABSTRACT

A method and an apparatus for executing a system function is provided. The method includes displaying a first configuration interface of a control system of a server, where a first tab is displayed on the first configuration interface, and the first tab is configured to configure an operating mode configuration option of a processor of the server; saving an option value of the first tab on the first configuration interface in response to a confirmation operation triggered on the first configuration interface; detecting a configuration state of the option value of the first tab in a startup process of the server; and executing an adjustment function through the control system in an operating process of the processor in a case where the configuration state is detected as a target state, where the adjustment function is configured to adjust an operating frequency of the processor.

### CROSS-REFERENCE TO RELATED APPLICATIONS

The present disclosure is a National Stage Entry under 35 U.S.C. § 371 of PCT International Application No. PCT/CN2025/117643, filed on Aug. 28, 2025, which claims the priority to Chinese Patent Application No. 202510595767.1, filed to the Chinese Patent Office on May 9, 2025 and entitled “Method and apparatus for executing system function” the entire contents of each of which are incorporated herein by reference for all purposes.

### TECHNICAL FIELD

The present disclosure relates to the technical field of servers, and particularly relates to a method and apparatus for executing a system function.

### BACKGROUND

With continuous development of servers, more and more functions are integrated into the servers, and users' demands for the servers are increasingly complicated. In this case, single fixed operating modes of processors of the servers in a traditional mode may no longer satisfy users' needs, with poor operating flexibility.

### SUMMARY

The present disclosure provides a method and apparatus for executing a system function, so as to at least solve a problem of poor operating flexibility of a processor of a server in the related art.

According to a first aspect, the present disclosure provides a method for executing a system function. The method includes: displaying a first configuration interface of a control system of a server, where a first tab is displayed on the first configuration interface, and the first tab is configured to configure an operating mode configuration option of a processor of the server; saving an option value of the first tab on the first configuration interface in response to a confirmation operation triggered on the first configuration interface; detecting a configuration state of the option value of the first tab in a startup process of the server; and executing an adjustment function through the control system in an operating process of the processor in a case where the configuration state is detected as a target state. The adjustment function is configured to adjust an operating frequency of the processor.

According to a second aspect, the present disclosure further provides an apparatus for executing a system function. The apparatus includes: a first display module, configured to display a first configuration interface of a control system of a server, where a first tab is displayed on the first configuration interface, and the first tab is configured to configure an operating mode configuration option of a processor of the server; a saving module, configured to save an option value of the first tab on the first configuration interface in response to a confirmation operation triggered on the first configuration interface; a first detection module, configured to detect a configuration state of the option value of the first tab in a startup process of the server; and a first execution module, configured to execute an adjustment function through the control system in an operating process of the processor in a case where the configuration state is detected as a target state. The adjustment function is configured to adjust an operating frequency of the processor.

According to a third aspect, the present disclosure further provides an electronic device. The electronic device includes: a memory, configured to store a computer program; and a processor, configured to implement steps of the method for executing a system function according to any one of the above descriptions when executing the computer program.

According to a fourth aspect, the present disclosure further provides a non-volatile readable storage medium. The non-volatile readable storage medium stores a computer program. When the computer program is executed by a processor, steps of the method for executing a system function according to any one of the above descriptions are implemented.

According to a fifth aspect, the present disclosure further provides a computer program product. The computer program product includes a computer program. When the computer program is executed by a processor, steps of the method for executing a system function according to any one of the above descriptions are implemented.

Through the present disclosure, the first configuration interface of the control system of the server is displayed to provide a selection of the operating mode configuration option of the processor of the server; the option value of the first tab on the first configuration interface is saved in response to the confirmation operation triggered on the first configuration interface; the configuration state of the option value of the first tab is detected in the startup process of the server; and then the adjustment function configured to adjust the operating frequency of the processor is executed through the control system in the operating process of the processor in a case where the configuration state is detected as the target state. That is, the operating mode of the processor of the server can be flexibly selected through the first configuration interface, the operating frequency of the processor can be flexibly adjusted when the processor operates in the target state, and the operating flexibility of the processor of the server can be effectively improved. Thus, a technical problem of poor operating flexibility of a processor of a server in the related art can be solved, and a technical effect of improving the operating flexibility of the processor of the server can be achieved.

### BRIEF DESCRIPTION OF THE DRAWINGS

To illustrate examples of the present disclosure more clearly, the accompanying drawings required for the examples will be briefly introduced below. Obviously, the drawings in the following description are merely some examples of the present disclosure, and those of ordinary skill in the art can still derive other drawings from these drawings without creative efforts.

FIG. 1 is a block diagram of a hardware structure for executing a system function according to an example of the present disclosure;

FIG. 2 is a flowchart of a method for executing a system function according to an example of the present disclosure;

FIG. 3 is a schematic diagram of a method for executing a system function according to an example of the present disclosure;

FIG. 4 is a first schematic diagram of a first configuration interface according to an example of the present disclosure;

FIG. 5 is a second schematic diagram of a first configuration interface according to an example of the present disclosure;

FIG. 6 is a third schematic diagram of a first configuration interface according to an example of the present disclosure;

FIG. 7 is a schematic diagram of a second configuration interface according to an example of the present disclosure;

FIG. 8 is a schematic diagram of a third configuration interface according to an example of the present disclosure;

FIG. 9 is a schematic control diagram of an operating process of a processor according to an example of the present disclosure;

FIG. 10 is a schematic control diagram of an operating process of a fan according to an example of the present disclosure;

FIG. 11 is a first flowchart of a dynamic energy efficiency management method for a server according to an example of the present disclosure;

FIG. 12 is a flowchart of a determination sub-flow a according to an example of the present disclosure;

FIG. 13 is a second flowchart of a dynamic energy efficiency management method for a server according to an example of the present disclosure; and

FIG. 14 is a block diagram of a structure for executing a system function according to an example of the present disclosure.

### DETAILED DESCRIPTION OF THE EMBODIMENTS

Technical solutions of examples of the present disclosure will be clearly and completely described below in conjunction with accompanying drawings in the examples of the present disclosure. Obviously, the examples described are merely some examples rather than all examples of the present disclosure. Based on the examples of the present disclosure, all other examples obtained by those of ordinary skill in the art without making creative efforts fall within the protection scope of the present disclosure.

It should be noted that, in the description of the present disclosure, the terms “include”, “comprise”, “contain” or any other variants thereof are intended to cover non-exclusive inclusions, such that a process, method, article or device including a series of elements not only includes those elements, but also includes those elements that are not explicitly listed, or includes elements inherent to the process, method, article or device. The terms such as “first” and “second” in the present disclosure are configured to distinguish between similar objects and are not intended to describe a specific order or sequence.

In order to make those skilled in the art better understand the solution of the present disclosure, the present disclosure will be further described in detail below with reference to the accompanying drawings and specific embodiments.

With reference to a specific application environment architecture or a specific hardware architecture on which execution of a method for executing a system function depends, the specific application environment architecture or the specific hardware architecture is described herein.

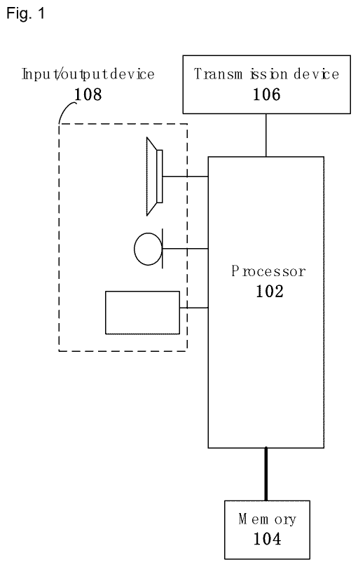

Method examples provided by the examples of the present disclosure may be executed in a server device or a similar arithmetic apparatus. With operation on the server device as an instance, FIG. 1 is a block diagram of a hardware structure for executing a system function in an example of the present disclosure. As shown in FIG. 1, the server device may include one or more (only one is shown in FIG. 1) processors 102 (the processors 102 may include, but are not limited to, processing apparatuses such as a microcontroller unit (MCU) or a field-programmable gate array (FPGA)) and a memory 104 configured to store data. The server device may further include a transmission device 106 for a communication function and an input/output device 108. Those of ordinary skill in the art may understand that a structure shown in FIG. 1 is merely illustrative and does not limit a structure of the server device. For instance, the server device may further include more or fewer components than those shown in FIG. 1, or have a different configuration from that shown in FIG. 1.

The memory 104 may be configured to store computer programs such as a software program and module of application software, and for instance, a computer program corresponding to a method for executing a system function in the example of the present disclosure. The processor 102 operates the computer program stored in the memory 104, so as to execute various functional applications and data processing, which implements the method. The memory 104 may include a high-speed random access memory, or a non-volatile memory, and for instance, one or more magnetic storage apparatuses, flash memories, or other non-volatile solid-state memories. In some instances, the memory 104 may further include a memory remotely arranged with respect to the processor 102, and the remote memories may be connected to the server device through a network. Instances of the network include, but are not limited to, the Internet, an enterprise intranet, a local area network, a mobile communication network, and a combination thereof.

The transmission device 106 is configured to receive or send data through one network. Specific instances of the network may include a wireless network provided by a communication provider of the server device. In one example, the transmission device 106 includes one network interface controller (NIC), which may be connected to other network devices through a base station so as to be in communication with the Internet. In one instance, the transmission device 106 may be a radio frequency (RF) module that is configured to be in wireless communication with the Internet.

An example of the present disclosure provides a method for executing a system function. By combining an execution flow of the method for executing a system function, the method is described in detail.

Terms involved in the present disclosure will be illustrated below:

BIOS: A basic input/output system is a first program that operates during startup of a computer, and is configured to initialize hardware, detect a hardware device, and load an operating system. The BIOS is stored in a read-only memory (ROM) chip on a mainboard, provides a most basic interaction layer for hardware and the operating system, and ensures smooth startup and operation of a computer system.

BMC: A baseboard management controller is a special microcontroller, and is configured to monitor and manage health and a state of hardware in a server, a workstation, and other calculating platforms. The BMC may remotely monitor and control the server through an intelligent platform management interface (IPMI) protocol, and may monitor a temperature, a voltage, a fan speed, a power state, etc., and perform remote control operations, such as startup, shutdown, and restart.

IPMI: The intelligent platform management interface is an industry standard specification, is configured to remotely monitor and manage system-level events, and is especially suitable for the server and other calculating devices.

Redfish: A “red fish” protocol, a “red fish standard” or a “red fish technology” is a standardized management interface, and is configured to perform unified management of servers and storage and network devices in modern data centers. It provides a representational state transfer (RESTful) application programming interface (API), making management of a hardware device more flexible and efficient.

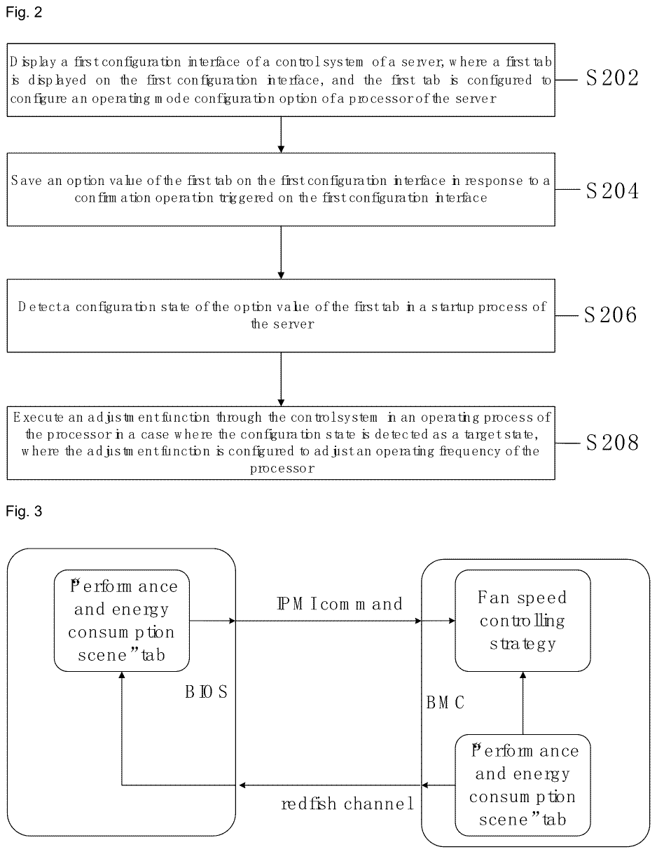

The example provides a method for executing a system function. FIG. 2 is a flowchart of a method for executing a system function according to an example of the present disclosure. As shown in FIG. 2, the method includes the following steps:

S202, a first configuration interface of a control system of a server is displayed. A first tab is displayed on the first configuration interface. The first tab is configured to configure an operating mode configuration option of a processor of the server.

S204, an option value of the first tab on the first configuration interface is saved in response to a confirmation operation triggered on the first configuration interface.

S206, a configuration state of the option value of the first tab is detected in a startup process of the server.

S208, an adjustment function is executed through the control system in an operating process of the processor in a case where the configuration state is detected as a target state. The adjustment function is configured to adjust an operating frequency of the processor.

Through the steps, the first configuration interface of the control system of the server is displayed to provide a selection of the operating mode configuration option of the processor of the server; the option value of the first tab on the first configuration interface is saved in response to the confirmation operation triggered on the first configuration interface; the configuration state of the option value of the first tab is detected in the startup process of the server; and then the adjustment function configured to adjust the operating frequency of the processor is executed through the control system in the operating process of the processor in a case where the configuration state is detected as the target state. That is, the operating mode of the processor of the server may be flexibly selected through the first configuration interface, the operating frequency of the processor can be flexibly adjusted when the processor operates in the target state, and the operating flexibility of the processor of the server may be effectively improved. Thus, a technical problem of poor operating flexibility of a processor of a server in the related art may be solved, and a technical effect of improving the operating flexibility of the processor of the server may be achieved.

In the example provided by S202, the control system of the server may be, but is not limited to, a comprehensive management platform integrating software and hardware functions, which is configured to monitor and manage an operating state of the server, and may perform initialization, configuration, performance adjustment and fault diagnosis of a hardware device. In some examples, the control system of the server may be, but is not limited to, an out-of-band system. The out-of-band system may be, but is not limited to, a system other than an in-band system of the server. The out-of-band system may provide lowest-level and direct hardware management and control for devices without relying on the operating system. The control system of the server may be, but is not limited to, the BIOS. The BIOS may be, but is not limited to, one ROM chip solidified on the mainboard of the server and a set of programs operating on the chip. The set of programs include a most important basic input output program of a computer, system setting information, a self-checking program after startup, and a system self-starting program. The BIOS may provide lowest-level and direct hardware setting and control for the devices. At present, functions of the BIOS are mainly used for device power-on self-test, hardware initialization, driver loading, system startup, etc. Generally, after startup the device into the system, the BIOS may automatically quit operation.

In some examples, the first configuration interface may be displayed on a display device in the server, or displayed on a display device externally connected to the server, which is not limitative and not specifically limited by the present disclosure.

In some examples, a moment of displaying the first configuration interface of the control system of the server may have various possibilities, which may be, but is not limited to, one of the following possibilities:

After the server is mounted for the first time or subjected to major hardware upgrading, the control system automatically loads and presents the first configuration interface, allowing a user to initialize the operating mode of the processor according to an expected use of the server, such as high-performance calculation, energy-saving operation of a data center, or a balanced mode.

In normal operation of the server, when the user needs to adjust performance or power consumption of the server, the first tab, that is, the operating mode configuration option of the processor, may be accessed and modified by re-entering the first configuration interface of the control system of the server, so as to adapt to a changing workload requirement, which is not limitative.

The control system of the server may automatically pop up a configuration interface when the user requests performance optimization or energy-saving strategy change, guiding the user to confirm or adjust the operating mode of the processor, and ensuring best balance between performance and efficiency of the server, which is not limitative.

In some examples, the first configuration interface may display the first tab, or may display a selection guide to the first tab, which is not limitative. The selection guide is configured to indicate a correspondence between each option value of the first tab and the operating mode of the processor of the server.

In some examples, the first tab may provide multi-angle selections of operating control mechanisms of the processor for the user, which is not limitative. For instance, the first tab may include, but is not limited to, a plurality of sub-tabs, and each of the sub-tabs is configured to indicate an operating mode of the processor at different angles. A sub-tab A is configured to indicate the operating mode of the processor. A sub-tab B is configured to indicate whether a frequency modulation function of the control system of the processor is enabled. A sub-tab C is configured to indicate a heat dissipation strategy of the processor. The user may implement multi-angle operating control of the processor by selecting respective option values of the sub-tab A, the sub-tab B, and the sub-tab C.

In some examples, the first tab may be configured to configure the operating mode configuration option of the processor of the server, which is not limitative. The operating mode configuration option may be configured to configure the operating mode of the processor of the server, which is not limitative.

In some examples, the operating mode of the processor is no longer limited to a fixed mode, and may be set as a plurality of modes according to operation requirements of the server, which is not limitative. The user may adjust the operating mode of the processor of the server according to a real-time operation requirement of the server. For instance, in a scene with a low time limit requirement for task execution of the server and a high energy consumption requirement of the server, the operating mode of the server may be configured as a more energy-saving mode, which is not limitative. In the more energy-saving mode, the server may be ensured to be in a lower energy consumption state as far as possible when there is no load.

In some examples, various operating modes of the processor may be set according to various possibilities of operation scenes of the server, which is not limitative. Various operating modes of the processor may include, but are not limited to, a high-performance calculation mode, an energy-saving mode, and an energy efficiency mode. When the high-performance calculation mode is selected, an energy-saving requirement of the server may give way to a task execution requirement of the server. When the energy-saving mode is selected, a priority of an energy-saving requirement of the server may be higher than that of a task execution requirement of the server. When the energy efficiency mode is selected, a task execution ability of the processor of the server may be adjusted according to a load of the processor of the server, so as to balance the energy-saving requirement and the task execution requirement.

In the example provided by S204, the confirmation operation may be configured to trigger the save operation of the option value of the first tab on the first configuration interface, which is not limitative.

In some examples, the confirmation operation may include, but is not limited to, a clicking operation on a determination option of the first configuration interface. The option value of the first tab on the first configuration interface may be saved in response to the confirmation operation triggered on the first configuration interface as follows: the user manually confirms a change of the option value through a “save and exit” option or a similar confirmation button on the first configuration interface after completing selection of the option value of the first tab, which is not limitative. In this case, the control system may save a new option value.

In some examples, the confirmation operation may include, but is not limited to, a series of instructions for automated script execution. A pre-determined condition (for instance, continuous operation time of the processor of the server reaches a certain threshold) may be preset through an automated script, and the confirmation operation may be automatically executed through the automated script when the server is under the pre-determined condition, which is not limitative. Through this design, the option value of the first tab on the first configuration interface may be saved in response to the confirmation operation triggered on the first configuration interface as follows: the control system is in communication with the automated script, and in response to a confirmation instruction of the automated script, the option value of the first tab on the first configuration interface is saved, which is not limitative.

In some examples, the option value of the first tab may be configured to indicate the operating mode configuration option of the processor, which is not limitative.

In some examples, the option value of the first tab may include, but is not limited to, a plurality of configuration states. The plurality of configuration states have a correspondence with a plurality of operating modes of the processor of the server. Different operating modes may be configured for the processor of the server by selecting different states of the option value of the first tab, which is not limitative.

In some examples, the server may be restarted immediately after the option value of the first tab on the first configuration interface is saved; or the server may be shut down so as to wait for next normal startup, which is not limitative.

In the example provided by S206, the option value of the first tab may include, but is not limited to, one or more sub-option values. In a case where the option value of the first tab includes the plurality of sub-option values, each of the sub-option values is presented as different options at different moments, and the configuration state may be, but is not limited to, a combination of a plurality of options. The configuration state of the option value of the first tab may be detected as follows: an option of each of the sub-option values is detected, which is not limitative. The obtained option combination is the configuration state.

In the example provided by S208, the adjustment function may be executed through the control system in the operating process of the processor as follows: the operating frequency of the processor is periodically adjusted through the control system, or an energy consumption parameter of the processor is monitored, and the operating frequency of the processor is adjusted through the control system when the energy consumption parameter reaches a parameter threshold, which is not limitative. The energy consumption parameter is configured to indicate energy consumption of the processor during task execution.

In some examples, the adjustment function may be executed through the control system in the operating process of the processor as follows: an operating frequency of a core device of the processor is adjusted through the control system, or operating frequencies of a core device and a non-core (namely, uncore) device of the processor are separately adjusted through the control system, which is not limitative.

In some examples, the step that the first configuration interface of the control system of the server is displayed includes the following step: a first sub-tab and a second sub-tab are displayed on the first configuration interface. The first sub-tab is configured to configure the operating mode configuration option. The second sub-tab is configured to configure a configuration option of the adjustment function to be enabled or disabled. The first tab includes the first sub-tab and the second sub-tab.

In some examples, the first sub-tab may be displayed on the first configuration interface to provide a selection of the operating mode configuration option, and the second sub-tab may be displayed to provide a selection of whether to enable the adjustment function, which is not limitative.

In some examples, the option value of the first sub-tab may be configured to indicate the operating mode configuration option of the processor, which is not limitative. The option value of the first sub-tab may be, but is not limited to, the energy efficiency mode option or other mode options other than the energy efficiency mode option.

In some examples, the option value of the second sub-tab may be, but is not limited to, an enabling option or a disabling option.

Based on the above contents, through addition of the first sub-tab and the second sub-tab, not only configuration flexibility and management accuracy of the control system of the server are enhanced, but also an operation flow of a user is simplified. Thus, the system can better adapt to diversified requirements.

In some examples, the step that the first configuration interface of the control system of the server is displayed further includes the following step: at least one third sub-tab is displayed on the first configuration interface in a case where an option value of the second sub-tab is an enabling option. The enabling option is configured to instruct the adjustment function to be enabled. The at least one third sub-tab is configured to configure a configuration option of at least one function parameter used in the adjustment function.

In some examples, the present disclosure may include, but is not limited to, a selection of displaying the at least one third sub-tab on the first configuration interface to provide the at least one function parameter in a case where the option value of the second sub-tab is the enabling option, that is, the adjustment function is enabled.

In some examples, the at least one function parameter may include, but is not limited to, a function parameter configured to indicate an expected adjustment state of the adjustment function, and/or a function parameter configured to indicate an adjustment triggering cycle of the adjustment function.

Through the above contents, the third sub-tab is dynamically displayed on the first configuration interface, such that a user can customize a frequency adjustment strategy according to own needs. Thus, flexibility and efficiency of the user in server performance management and energy efficiency control are improved, and more delicate and intelligent dynamic energy efficiency management is implemented.

In some examples, the step that the at least one third sub-tab is displayed on the first configuration interface includes the following step: a parameter threshold tab and/or a function cycle tab are/is displayed on the first configuration interface. The parameter threshold tab is configured to configure a configuration option of a parameter threshold used in the adjustment function. The function cycle tab is configured to configure a configuration option of an execution cycle of the adjustment function. The at least one third sub-tab includes the parameter threshold tab and/or the function cycle tab.

In some examples, the parameter threshold may be configured to indicate the expected adjustment state of the adjustment function, which is not limitative. The parameter threshold may be, but is not limited to, an expected value of a proportion of active time of the processor in one entire execution cycle.

In some examples, the execution cycle may be configured to indicate an interval between two times of execution of the adjustment function of the control system, which is not limitative.

In some examples, the at least one third sub-tab may be displayed on the first configuration interface as follows: an automatic disabling tab is displayed on the first configuration interface, which is not limitative. The automatic disabling tab is configured to configure an automatic disabling function of the adjustment function to be enabled or disabled. The automatic disabling function is configured to automatically disable the adjustment function in a case where a frequency of cases that a busyness parameter of the processor is less than a busyness threshold is greater than or equal to a frequency threshold. The busyness parameter is configured to indicate busyness of the processor during task execution.

In some examples, the control system may monitor the operating state of the processor in a case where the adjustment function is enabled and the automatic disabling function is enabled, and may disable the adjustment function in a case where the operating state of the processor remains inactive for a long time, that is, display the option value of the second sub-tab as the disabling option, which is not limitative. In some examples, the control system may monitor a usage ratio of the processor for a long time, and disable the adjustment function and display the option value of the second sub-tab as the disabling option in a case where the usage ratio of the processor remains at a low level for a long time.

In some examples, the step that the first sub-tab and the second sub-tab are displayed on the first configuration interface includes one of the following steps:
on the first configuration interface, an option value of the first sub-tab is displayed as an energy efficiency mode option, and an option value of the second sub-tab is displayed as an enabling option, where the energy efficiency mode option is configured to configure an operating mode of the processor of the server as an energy efficiency mode, the energy efficiency mode is configured to control the processor to balance an energy efficiency of the processor in the operating process, and the enabling option is configured to instruct the adjustment function to be enabled; and
on the first configuration interface, the option value of the first sub-tab is displayed as another mode option, and the option value of the second sub-tab is displayed as a disabling option, where the another mode option are configured to configure an operating mode of the processor of the server as a mode other than the energy efficiency mode, and the disabling option is configured to instruct the adjustment function to be disabled.

In some examples, the adjustment function may be enabled in linkage in a case where the operating mode of the processor of the server is the energy efficiency mode, which is not limitative. The adjustment function may be disabled by default in a case where the operating mode of the processor of the server is another mode other than the energy efficiency mode, which is not limitative.

In some examples, the energy efficiency mode may be configured to control the processor to balance the energy efficiency of the processor in the operating process, that is, to balance energy consumption of the processor and task execution efficiency of the processor, which is not limitative. All devices that execute tasks through energy consumption in the processor may reduce energy consumption while maintaining certain task execution efficiency in the energy efficiency mode, which is not limitative. For instance, the operating frequency of the processor may be dynamically adjusted according to an active state proportion of the processor to balance the energy efficiency of the processor in the energy efficiency mode, which is not limitative.

In some examples, after the first configuration interface displays the option value of the first sub-tab as the other mode options and displays the option value of the second sub-tab as the disabling option, the user may manually enable the adjustment function by modifying the option value of the second sub-tab as the enabling option on the first configuration interface.

Through the above contents, when the option value of the first sub-tab is set as the energy efficiency mode option, the adjustment function is enabled in linkage, the user does not need to perform further manual selection, and an operation is simplified while use requirements are satisfied.

In some examples, the step that the configuration state of the option value of the first tab is detected includes the following steps: an option value of a second sub-tab displayed on the first configuration interface is detected, where the first tab includes a first sub-tab and the second sub-tab, the first sub-tab is configured to configure the operating mode configuration option, and the second sub-tab is configured to configure a configuration option of the adjustment function to be enabled or disabled; and it is determined that the configuration state is detected as the target state in a case where the option value of the second sub-tab is an enabling option.

In some examples, the configuration option of the adjustment function may be configured to be enabled or disabled through the second sub-tab, and it may be determined that the configuration state is detected as the target state directly in a case where the option value of the second sub-tab is detected as the enabling option, which is not limitative.

In some examples, whether the option value of the first sub-tab is the energy efficiency mode option may be detected after the option value of the second sub-tab is detected as the disabling option; and alarm information may be displayed on the first configuration interface in a case where the option value of the first sub-tab is detected as the energy efficiency mode option, which is not limitative. The alarm information is configured to indicate an abnormal state of the adjustment function.

In some examples, before the configuration state of the option value of the first tab is detected in the startup process of the server, the method further includes the following steps: a second configuration interface of a controller of the server is displayed, where a second tab is displayed on the second configuration interface, and the second tab is configured to configure the operating mode configuration option for the control system; the controller sends an option value of the second tab on the second configuration interface to the control system in response to a confirmation operation triggered on the second configuration interface; and the control system configures the operating mode configuration option according to the option value of the second tab.

In some examples, the user may configure the operating mode and the adjustment function of the processor of the server through the first configuration interface of the control system of the server, or configure the operating mode and the adjustment function of the processor of the server through the second configuration interface of the controller of the server, which is not limitative. The operating mode and the adjustment function of the processor may be configured through one or both of the first configuration interface and the second configuration interface, which is not limitative.

In some examples, the controller of the server may be, but is not limited to, a control device for server management and monitoring. Similarly, the controller of the server may be, but is not limited to, an out-of-band system. In some examples, the controller of the server may be, but is not limited to, a BMC, a complex programmable logic device (CPLD), etc. The BMC does not depend on the processor, the BIOS, or a user operating system of the device. BMC hardware may be implemented as an independent board mounted on a device mainboard or integrated on a mainboard. The BMC is not limited by existing management methods based on the user operating system. For instance, in a case where the user operating system does not have a response or performs no loading, the device may still be switched on and off through the BMC, and device-related information may be extracted.

In some examples, functions that may be achieved by the second tab may be similar to those of the first tab, which is not limitative. The user may configure the operating mode configuration option for the control system by configuring the option value of the second tab, and finally configure the operating mode of the processor of the server.

In some examples, the configuration state of the option value of the second tab may be consistent with the configuration state of the option value of the first tab, or the second tab may be given a smaller selection range of the configuration state of the option value compared with the first tab, which is not limitative.

In some examples, the second configuration interface is similar to the first configuration interface, and may be displayed on a display device in the server or on a display device externally connected to the server. The first configuration interface and the second configuration interface may be displayed on different display devices, such that the user can control the operating mode of the processor in many places, which is not limitative.

In some examples, the confirmation operation on the second configuration interface may be similar to the confirmation operation on the first configuration interface, which is not limitative.

In some examples, the step that the controller sends the option value of the second tab on the second configuration interface to the control system in response to the confirmation operation triggered on the second configuration interface may include, but is not limited to, the step that the BMC sends the option value of the second tab on the second configuration interface to the BIOS through the IPMI or the redfish in response to the confirmation operation triggered on the second configuration interface in a case where the BMC is used as the controller and the BIOS is used as the control system.

Through the above contents, not only the first configuration interface of the control system can be displayed, but also the second configuration interface of the controller can be displayed. Thus, a way for the user to configure the operating mode of the processor is broadened.

In some examples, the step that the control system configures the operating mode configuration option according to the option value of the second tab includes the following steps: the control system configures an operating mode of the processor as the option value of the second tab; a configuration option of the adjustment function is configured to be enabled in a case where the option value of the second tab is an energy efficiency mode option, where the energy efficiency mode option is configured to configure the operating mode of the processor of the server as an energy efficiency mode, and the energy efficiency mode is configured to control the processor to balance an energy efficiency of the processor in the operating process; and the configuration option of the adjustment function is configured to be disabled in a case where the option value of the second tab is another mode option. The another mode option is configured to configure the operating mode of the processor of the server as a mode other than the energy efficiency mode.

In some examples, the control system may configure the operating mode of the processor as the option value of the second tab in a case where the option value of the second tab sent by the controller is received, configure the configuration option of the adjustment function to be enabled in a case where the option value of the second tab is the energy efficiency mode option, that is, enable the adjustment function in linkage, and configure the configuration option of the adjustment function to be disabled in a case where the option value of the second tab is the other mode options other than the energy efficiency mode option, that is, disable the adjustment function, which is not limitative.

In some examples, a tab configured to directly configure the configuration option of the adjustment function to be enabled or disabled is not set in the second configuration interface. Thus, the adjustment function cannot be directly enabled or disabled through the second configuration interface, and the adjustment function can only be indirectly enabled or disabled by configuring the operating mode of the processor through the second configuration interface.

In some examples, the method further includes the following step: the control system configures a configuration option of at least one function parameter used in the adjustment function as a default parameter corresponding to each of the at least one function parameter in a case where the option value of the second tab is the energy efficiency mode option. The at least one function parameter includes a parameter threshold used in the adjustment function, and/or an execution cycle of the adjustment function.

In some examples, the control system may configure the configuration option of the at least one function parameter used in the adjustment function as the default parameter corresponding to each of the at least one function parameter in a case where the option value of the second tab is the energy efficiency mode option, that is, the adjustment function is indirectly enabled through the second configuration interface, which is not limitative.

In some examples, before the configuration state of the option value of the first tab is detected in the startup process of the server, the method further includes the following steps: a third configuration interface of a controller of the server is displayed, where a third tab is displayed on the third configuration interface, and the third tab is configured to configure a heat dissipation strategy configuration option of a heat dissipation device of the server; the controller detects an option value of the third tab in response to a confirmation operation triggered on the third configuration interface; the controller sends a first configuration instruction to the control system in a case where the option value of the third tab is an energy efficiency strategy option, where the first configuration instruction is configured to instruct the control system to configure an operating mode of the processor as an energy efficiency mode and to configure a configuration option of the adjustment function to be enabled, the energy efficiency mode is configured to control the processor to balance an energy efficiency of the processor in the operating process, the energy efficiency strategy option is configured to configure a heat dissipation strategy of the heat dissipation device as an energy efficiency strategy, and the energy efficiency strategy is configured to instruct a heat dissipation parameter of the heat dissipation device to be adjusted according to the operating frequency of the processor in the operating process; and the control system executes the first configuration instruction in the startup process of the server, and the adjustment function is executed through the control system in the operating process of the processor.

In some examples, the third configuration interface of the controller of the server is displayed to provide a selection of the heat dissipation strategy configuration option of the heat dissipation device of the server for the user, which is not limitative.

In some examples, the selection of the heat dissipation strategy configuration option of the heat dissipation device of the server may be linked with a selection of the operating mode of the processor of the server, which is not limitative. The operating mode of the processor may be configured as the energy efficiency mode in linkage and the adjustment function may be enabled in linkage in a case where the heat dissipation strategy configuration option is the energy efficiency strategy option, which is not limitative.

In some examples, the user may configure the operating mode and the adjustment function of the processor through one or more of the first configuration interface, the second configuration interface, and the third configuration interface, which is not limitative.

In some examples, the heat dissipation strategy configuration options may include, but are not limited to, a low-noise strategy option, an energy efficiency strategy option, and a high-performance strategy option. When the heat dissipation device operates according to a low-noise strategy, the heat dissipation device may provide a lower heat dissipation intensity (for instance, a fan operates at a lower speed), which is not limitative. When the heat dissipation device operates according to an energy efficiency strategy, a heat dissipation intensity provided by the heat dissipation device may be dynamically adjusted according to task execution busyness of the processor (for instance, a fan speed is constantly adjusted with the task execution busyness of the processor), which is not limitative. When the heat dissipation device operates according to a high-performance strategy, the heat dissipation device may provide a higher heat dissipation intensity (for instance, a fan operates at a higher speed), which is not limitative.

In some examples, the energy efficiency strategy may be configured to instruct the heat dissipation parameter of the heat dissipation device to be adjusted according to the operating frequency of the processor in the operating process, which is not limitative. The heat dissipation parameter may be configured to indicate the heat dissipation intensity of the heat dissipation device, which is not limitative. The heat dissipation parameter may include, but is not limited to, the fan speed.

In some examples, the third configuration interface is similar to the first configuration interface, and may be displayed on a display device in the server or on a display device externally connected to the server. The first configuration interface, the second configuration interface and the third configuration interface may be displayed on different display devices, such that the user may control the operating mode of the processor in many places, which is not limitative.

In some examples, the confirmation operation on the third configuration interface may be similar to the confirmation operation on the first configuration interface, which is not limitative.

In some examples, the step that the controller sends the first configuration instruction to the control system may include, but is not limited to, the step that the BMC sends the first configuration instruction to the BIOS through the IPMI or the redfish in a case where the BMC is selected as the controller and the BIOS is selected as the control system.

Based on the above contents, through comprehensive configuration in the startup process of the server, intelligent linkage between the operating mode of the processor and the heat dissipation strategy is implemented. Thus, workload requirements are satisfied, and meanwhile, energy efficiency and heat dissipation efficiency of the server are significantly improved. The comprehensive energy efficiency management method not only simplifies a configuration flow and enhances usability and management efficiency of the server, but also ensures operation stability and reliability of the server through dynamic adjustment of frequency and heat dissipation parameters.

In some examples, after the configuration state of the option value of the first tab is detected, the method further includes the following steps: the control system sends a second configuration instruction to a controller of the server in a case where the configuration state is detected as the target state, where the second configuration instruction is configured to instruct the controller to configure a heat dissipation strategy of a heat dissipation device of the server as an energy efficiency strategy, and the energy efficiency strategy is configured to instruct a heat dissipation parameter of the heat dissipation device to be controlled according to the operating frequency of the processor in the operating process; and the controller executes the second configuration instruction, and the heat dissipation parameter of the heat dissipation device is controlled according to the operating frequency of the processor in the operating process.

In some examples, the heat dissipation strategy of the heat dissipation device may be configured as the energy efficiency strategy in linkage in a case where the adjustment function is enabled, which is not limitative.

In some examples, the controller may control the heat dissipation parameter of the heat dissipation device according to the operating frequency of the processor in the operating process, which is not limitative.

In some examples, FIG. 3 is a schematic diagram of a method for executing a system function according to an example of the present disclosure. As shown in FIG. 3, a selection function of the operating mode may be supported through a preset tab of a “performance and energy consumption scene” tab (that is, the first tab) in a BIOS setup interface (that is, the first configuration interface), which is not limitative. After the BIOS setup interface is entered and an option value is selected for the first tab, a series of sub-tabs may be set according to a preset strategy information table in linkage, so as to conform to a current operating mode, and may be sent to the BMC through an IPMI command in real time to switch a fan speed controlling strategy (that is, the heat dissipation strategy of the heat dissipation device). When the server saves settings and is restarted, the settings may take effect. Meanwhile, a BMC interface (that is, the second configuration interface) further provides one tab of the “performance and energy consumption scene” tab (that is, the second tab). After the second tab is set to an option value in the BMC interface, the option value may be sent to the BIOS through a redfish channel and the fan speed controlling strategy may be modified synchronously. When the server is restarted, the settings may take effect. In a startup process, the BIOS may set a series of sub-tabs in linkage according to the option value sent by the BMC through the redfish and according to the preset strategy information table, so as to conform to the current operating mode. It should be emphasized that one BIOS tab (that is, the second sub-tab) named “dynamic frequency modulation” (that is, the adjustment function) may be enabled in linkage when the “performance and energy consumption scene” tab (that is, the first sub-tab in the first tab) selects the energy efficiency mode option, which is not limitative.

In some examples, after the adjustment function is executed through the control system in the operating process of the processor, the method further includes the following step: the control system controls a heat dissipation parameter of a heat dissipation device of the server according to the operating frequency of the processor in the operating process.

In some examples, the control system may control the heat dissipation parameter of the heat dissipation device according to the operating frequency of the processor in the operating process, and the controller may control the operation of the heat dissipation device according to the heat dissipation parameter determined by the control system, which is not limitative.

In some examples, the step that the control system controls the heat dissipation parameter of the heat dissipation device of the server according to the operating frequency of the processor in the operating process includes the following steps: the control system generates a target heat dissipation parameter according to the operating frequency of the processor in the operating process; the control system sends the target heat dissipation parameter to a controller of the server; and the controller controls an operation (namely, running) of the heat dissipation device based on the target heat dissipation parameter.

Through the above contents, the control system generates the target heat dissipation parameter according to the operating frequency of the processor in the operating process, and the control system only needs to send the generated target heat dissipation parameter to the controller without sending each operating frequency to the controller. Thus, data transmission pressure between the control system and the controller is reduced.

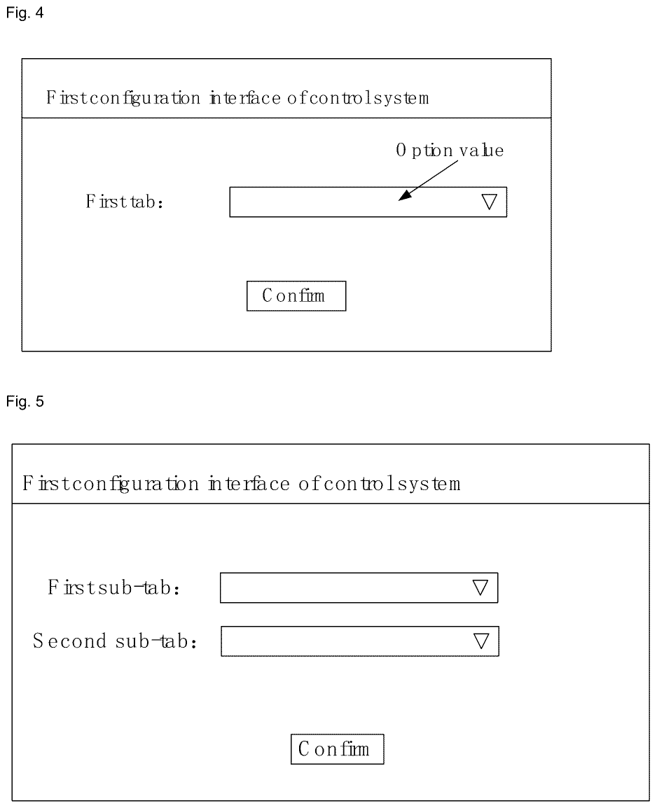

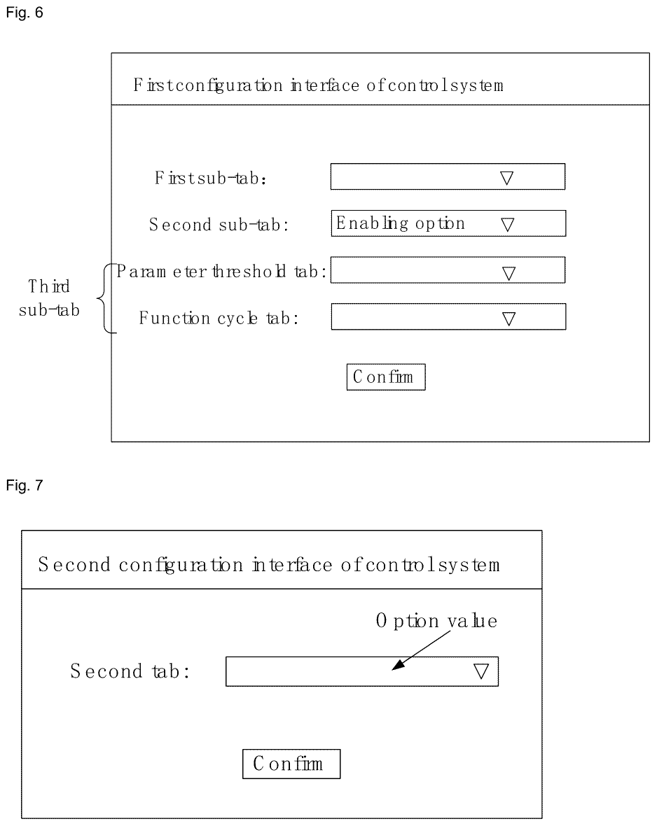

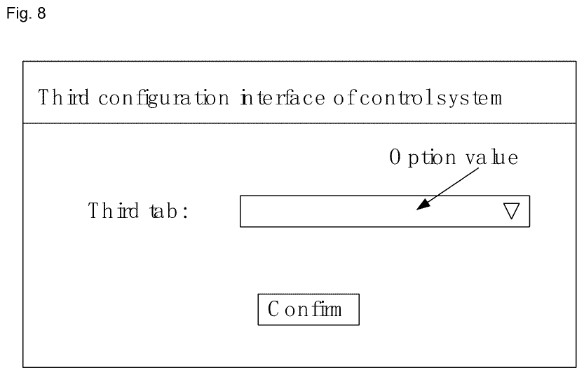

In some examples, FIG. 4 is a first schematic diagram of a first configuration interface according to an example of the present disclosure. FIG. 5 is a second schematic diagram of a first configuration interface according to an example of the present disclosure. FIG. 6 is a third schematic diagram of a first configuration interface according to an example of the present disclosure. FIG. 7 is a schematic diagram of a second configuration interface according to an example of the present disclosure. FIG. 8 is a schematic diagram of a third configuration interface according to an example of the present disclosure. The first configuration interface may be displayed as shown in FIG. 4, FIG. 5 or FIG. 6 on a first display device of the server, the second configuration interface may be displayed as shown in FIG. 7 on a second display device of the server, and the third configuration interface may be displayed as shown in FIG. 8 on a third display device of the server, which is not limitative. The user may operate on the first display device, the second display device and the third display device to configure the operating mode of the processor, configure the heat dissipation strategy of the heat dissipation device, and configure the adjustment function to be enabled or not.

In some examples, the step that the heat dissipation parameter of a heat dissipation device of the server is controlled according to the operating frequency of the processor in the operating process includes the following steps: processor frequencies and heat dissipation parameters having a correspondence are searched for a current heat dissipation parameter corresponding to a current processor frequency of the processor, where the processor frequencies and the heat dissipation parameters having the correspondence are established according to a maximum processor frequency and a minimum processor frequency of the processor; and an operation (namely, running) of the heat dissipation device is controlled to operate based on the current heat dissipation parameter.

In some examples, parameters may be adjusted according to an adjustment amplitude of the processor frequency, such that the adjustment amplitude of the heat dissipation parameter matches the adjustment amplitude of the processor frequency, which is not limitative.

In some examples, the processor frequencies and the heat dissipation parameters having the correspondence may be established according to the maximum processor frequency and the minimum processor frequency of the processor, which is not limitative. The correspondence is established based on maximum and minimum frequencies of the processor, which means that the heat dissipation device can find a most suitable heat dissipation parameter in an entire operating frequency range of the processor. This helps to ensure that the heat dissipation efficiency can be increased in time at high frequency while avoiding excessive operation of the heat dissipation device at low frequency, so as to maximize energy efficiency.

By looking up a table of the processor frequencies and the heat dissipation parameters having the correspondence, a required heat dissipation level of a current processor frequency may be determined in real time. The dynamic association enables the heat dissipation device to accurately respond to heat changes of the processor, and avoids a problem of supercooling or overheating under a fixed heat dissipation strategy.

In some examples, before the processor frequencies and the heat dissipation parameters having the correspondence are searched for the current heat dissipation parameter corresponding to the current processor frequency of the processor, the method further includes the following steps: a target quantity is calculated according to the maximum processor frequency, the minimum processor frequency and a unit frequency, where the unit frequency is configured to indicate a minimum frequency value by which the processor is allowed to be adjusted; based on the target quantity, the processor frequencies between the minimum processor frequency and the maximum processor frequency are divided into a plurality of processor frequencies according to the unit frequency, and the heat dissipation parameters between a minimum heat dissipation parameter and a maximum heat dissipation parameter are divided into a plurality of heat dissipation parameters according to the target quantity, where a total frequency quantity of the plurality of processor frequencies, the minimum processor frequency and the maximum processor frequency is the target quantity, and a total parameter quantity of the plurality of heat dissipation parameters, the minimum heat dissipation parameter and the maximum heat dissipation parameter is the target quantity; and a correspondence between the maximum processor frequency and the maximum heat dissipation parameter, a correspondence between the minimum processor frequency and the minimum heat dissipation parameter, and a one-to-one correspondence between the plurality of processor frequencies and the plurality of heat dissipation parameters are established, and the processor frequencies and the heat dissipation parameters having the correspondence are obtained. The larger the processor frequency, the larger the corresponding heat dissipation parameter.

In some examples, an adjustment value of the processor frequency may be, but is not limited to, an integral multiple of the unit frequency.

In some examples, a ratio of a difference between the maximum processor frequency and the minimum processor frequency to the unit frequency may be calculated to obtain the target quantity.

In some examples, both an adjustable space of the processor frequencies and an adjustable space of the heat dissipation parameters of the heat dissipation device may be divided into an identical quantity of parts, so as to adjust the heat dissipation parameters of the heat dissipation device according to an identical adjustment intensity to adjustment of the processor frequencies, which is not limitative.

In some examples, Table 1 is a corresponding table of processor frequencies and heat dissipation parameters according to an example of the present disclosure. The sum of a maximum frequency Freqcore_max of the core device and a maximum frequency Frequncore_max of an uncore device of the processor may be regarded as the maximum processor frequency, and the sum of a minimum frequency Freqcore_min of the core device and a minimum frequency Frequncore_min of the uncore device of the processor may be regarded as the minimum processor frequency, which is not limitative. If 0.1 GHz is selected as the unit frequency and k is the target quantity, k=(Freqcore_max+Frequncore_max−Freqcore_min−Frequncore_min)/0.1 GHz. The heat dissipation parameter may be, but is not limited to, a percentage of a fan speed in a maximum fan speed. The maximum heat dissipation parameter may be, but is not limited to, 100%, and the minimum heat dissipation parameter may be, but is not limited to, 10%.

TABLE 1

| Processor frequency | Fan speed |
|---|---|
| Freqcore_max + Frequncore_max | 100% |
| . . . | . . . |
| (Freqcore_min + Frequncore_min) + 0.3 GHz | 10% + 3 × 90%/k |
| (Freqcore_min + Frequncore_min) + 0.2 GHz | 10% + 2 × 90%/k |
| (Freqcore_min + Frequncore_min) + 0.1 GHz | 10% + 1 × 90%/k |
| Freqcore_min + Frequncore_min | 10% |

Through the above contents, a delicate correspondence between the processor frequencies and the heat dissipation parameters is established, such that dynamic energy efficiency management and intelligent heat dissipation control are implemented. Thus, energy efficiency of the server is improved, and operation stability and reliability of the server are ensured.

In some examples, the step that the adjustment function is executed through the control system in the operating process of the processor includes the following step: the operating frequency of the processor is adjusted according to processor information corresponding to the target state through the control system in the operating process of the processor.

In some examples, the processor information may be configured to indicate busyness of the processor during task execution, which is not limitative. The processor information may include, but is not limited to, a usage ratio of the processor.

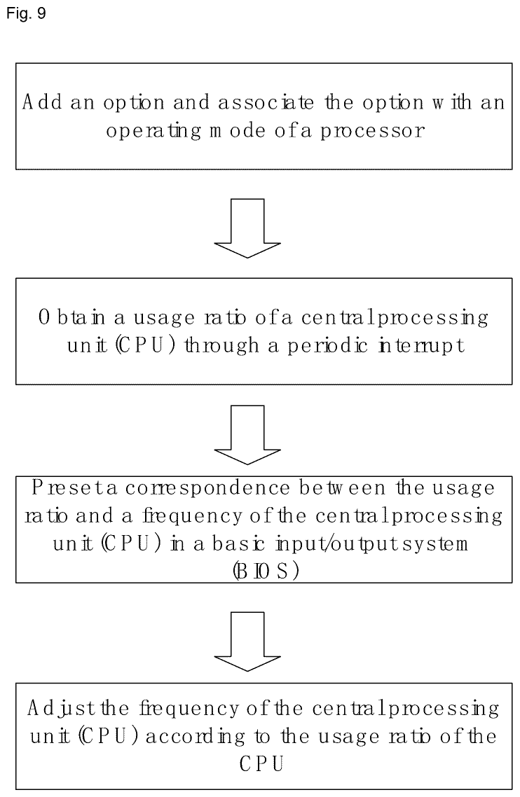

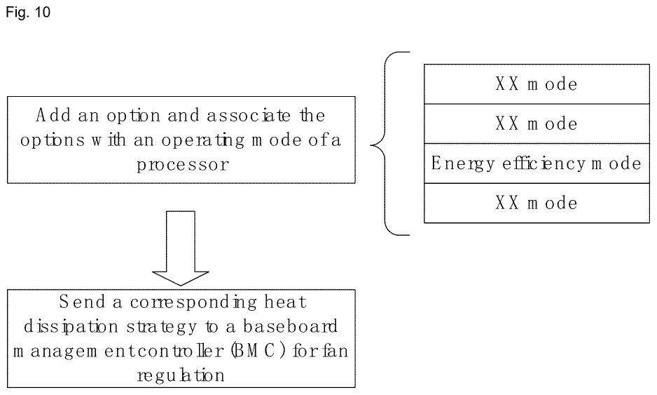

In some examples, FIG. 9 is a schematic control diagram of an operating process of a processor according to an example of the present disclosure. FIG. 10 is a schematic control diagram of an operating process of a fan according to an example of the present disclosure. As shown in FIG. 9, a plurality of options corresponding to the operating mode of the processor may be added, which is not limitative. The user may select the operating mode of the processor through option selection. In a case of selecting the energy efficiency mode, a usage ratio of a central processing unit (CPU) is obtained through a periodic interrupt. In addition, a correspondence between the usage ratio and a frequency of the CPU is preset in the BIOS. Thus, the frequency of the CPU may be dynamically adjusted according to the usage ratio of the CPU. As shown in FIG. 10, a correspondence between the operating mode of the processor and the heat dissipation strategy of the heat dissipation device may be preset after the plurality of options corresponding to the operating mode of the processor are added, and the heat dissipation strategy corresponding to the selected operating mode of the processor may be sent to the BMC, which is not limitative. The BMC performs fan regulation according to the received heat dissipation strategy.

In some examples, the step that the operating frequency of the processor is adjusted according to the processor information corresponding to the target state includes the following steps: a core operating frequency of the processor is adjusted according to first processor information corresponding to a core device, and a non-core operating frequency of the processor is adjusted according to second processor information corresponding to a non-core device. The processor information includes the first processor information and the second processor information. The processor includes the core device and the non-core device. The operating frequency of the processor includes the core operating frequency and the non-core operating frequency.

In some examples, the processor may include, but is not limited to, the core device and the non-core device. The step that the operating frequency of the processor is adjusted according to the processor information corresponding to the target state may include, but is not limited to, the steps that the core operating frequency is adjusted according to the first processor information corresponding to the core device and the non-core operating frequency is adjusted according to the second processor information corresponding to the non-core device.

In some examples, the core device refer to an execution unit of a processor, that is, one or more processing cores, which is not limitative. Each core is an independent calculation unit, and can execute instructions, process data and perform arithmetic and logical operation. A modern processor generally includes a plurality of cores. The cores may execute different tasks at the same time and provide parallel calculation capabilities, thus significantly improving performance of the processor.

In some examples, the non-core device, also referred to as uncore (that is, uncore device) or a northbridge/southbridge device, may process other functions other than calculation tasks in the processor, which is not limitative. The non-core device is mainly configured to coordinate communication between the plurality of cores, managing memory access, providing input/output (I/O) control, and processing interaction with other hardware components of the system. The non-core device may be, but is not limited to, a memory controller configured to communication with a system memory and managing data reading and writing operations, an I/O controller configured to process input/output operations, etc.

In some examples, the first processor information may be configured to indicate busyness of the core device during task execution, which is not limitative. The second processor information may be configured to indicate busyness of the non-core device during task execution, which is not limitative.

Through the above contents, energy consumption of the processor of the server may be controlled more accurately by adjusting the operation frequencies of the core device and the non-core device separately.

In some examples, the step that the core operating frequency of the processor is adjusted according to the first processor information corresponding to the core device includes the following steps: a first state parameter of the core device is detected, where the first processor information includes the first state parameter, and the first state parameter is configured to indicate a time proportion of the core device operating in an active working state (namely, active state); a target core operating frequency is calculated according to the first state parameter and a current core operating frequency of the processor; and the core operating frequency of the processor is adjusted from the current core operating frequency to the target core operating frequency.

In some examples, the first state parameter may be configured to indicate an overall condition of the time proportion of a plurality of target core devices operating in an active working state, which is not limitative.

In some examples, the step that the first state parameter of the core device is detected includes the following steps: a hyper-threading configuration option of the control system is obtained, where the hyper-threading configuration option is configured to indicate whether to enable a hyper-threading function of the control system; a plurality of virtual cores in the processor are determined as one core device in a case where the hyper-threading configuration option is detected to be configured to indicate that the hyper-threading function is enabled, to obtain one or more core devices; each virtual core in the processor is determined as one core device in a case where the hyper-threading configuration option is detected to be configured to indicate that the hyper-threading function is disabled, to obtain one or more core devices; each of the one or more core devices in the processor is traversed; a state parameter corresponding to each of the one or more core devices is detected, where the state parameter corresponding to each of the one or more core devices is configured to indicate a time proportion of the corresponding core device operating in an active working state; at least one, having the corresponding state parameter greater than or equal to a first parameter threshold, of the one or more core devices is determined as one or more target core devices; and an average value of one or more state parameters of the one or more target core devices is determined as the first state parameter.

In some examples, the hyper-threading function may create two independent thread contexts on one physical core, which is not limitative. Each context has its own register set and other necessary processor resources. This means that one processor supporting a hyper-threading technology may process a plurality of threads at the same time. Even when a thread is waiting for data or resources, the processor may immediately turn to another thread instead of being idle, thus improving the usage ratio of the processor and overall calculation efficiency. That is, in a case where the hyper-threading function is enabled, one core device of the processor may derive a plurality of virtual cores.

In some examples, a target core device that possibly has a frequency adjustment requirement may be determined by comparing the state parameter corresponding to each core device with the first parameter threshold, which is not limitative.

Through the above contents, in a case where hyper-threading is enabled, the plurality of virtual cores are regarded as one actual core device, which helps to evaluate an actual core load more accurately.

In some examples, the step that the target core operating frequency is calculated according to the first state parameter and the current core operating frequency of the processor includes the following steps: a first difference between the first state parameter and a second parameter threshold is calculated; a frequency adjustment amount corresponding to each target core device is calculated according to a second difference between the state parameter of each of the one or more target core devices and the second parameter threshold and a unit frequency in a case where the first difference is greater than or equal to a third parameter threshold, where the unit frequency is configured to indicate a minimum frequency value by which the processor is allowed to be adjusted; and a sum of a current core operating frequency corresponding to each of the one or more target core devices and the frequency adjustment amount corresponding to each of the one or more target core devices is determined as the target core operating frequency corresponding to each of the one or more target core devices.

In some examples, whether to adjust the operating frequency of each of the one or more target core devices in the processor currently may be determined by comparing the first difference between the average value (that is, the first state parameter) of the one or more state parameters of the one or more target core devices and the second parameter threshold with the third parameter threshold, which is not limitative. In a case where the first difference is greater than or equal to the third parameter threshold, it indicates that the plurality of target core devices of the processor have high overall frequency modulation requirements. In this case, the frequency adjustment amount corresponding to each target core device is calculated according to the second difference between the state parameter of each target core device and the second parameter threshold and the unit frequency, and a frequency of each target core device is adjusted according to each frequency adjustment amount. In a case where the first difference is less than the third parameter threshold, it indicates that the plurality of target core devices of the processor have low overall frequency modulation requirements. In this case, in order to save operation resources, a frequency of each target core device is not adjusted.

In some examples, the step that a non-core operating frequency of the processor is adjusted according to second processor information corresponding to the non-core device includes the following steps: a second state parameter of the non-core device is detected, where the second processor information includes the second state parameter, and the second state parameter is configured to indicate a time proportion of the non-core device operating in an active working state; a target non-core operating frequency is calculated according to the second state parameter and a current non-core operating frequency of the processor; and the non-core operating frequency of the processor is adjusted from the current non-core operating frequency to the target non-core operating frequency.

In some examples, the second state parameter may be configured to indicate the time proportion of the non-core device operating in the active working state, which is not limitative.

In some examples, the step that the target non-core operating frequency is calculated according to the second state parameter and the current non-core operating frequency of the processor includes the following steps: each of the non-core devices is traversed; a third difference between the second state parameter of the currently traversed non-core device and a fourth parameter threshold is calculated; a frequency adjustment amount corresponding to the currently traversed non-core device is calculated according to the third difference and a unit frequency in a case where the third difference is greater than or equal to a fifth parameter threshold, where the unit frequency is configured to indicate a minimum frequency value by which the processor is allowed to be adjusted; and the sum of a current core operating frequency corresponding to the currently traversed non-core device and the frequency adjustment amount corresponding to the currently traversed non-core device is determined as the target non-core operating frequency corresponding to the currently traversed non-core device.

In some examples, whether each non-core device needs to adjust the operating frequency separately may be determined, which is not limitative. In a case where a third difference between a second state parameter of a non-core device and a fourth parameter threshold is greater than or equal to the fifth parameter threshold, it is determined that an operating frequency of the non-core device needs to be adjusted. In a case where a third difference between a second state parameter of a non-core device and a fourth parameter threshold is less than the fifth parameter threshold, it is determined that an operating frequency of the non-core device does not need to be adjusted temporarily.

In some examples, the present disclosure further provides a dynamic energy efficiency management method for a server. Generally, under the operating system, an operating program applies to a kernel layer of the system for a higher central processing unit (CPU) operating frequency. When a very large load is brought by the operating program, the logic cannot have other influence. However, when a small load is brought by the operating program or operation time is short, extra system power consumption can be caused due to application of excessive CPU operating frequency, and an energy efficiency level of the entire system can be reduced. In order to avoid such a scene, a tab may be provided to set a performance and energy consumption scene under the BIOS and the BMC, which is not limitative. When the high-performance calculation mode is selected, the system is not too involved in adjustment of CPU frequency. When the energy-saving mode is selected, the system may enable all energy-saving-related options to ensure that the system is in a lowest energy consumption state when there is no load. When the energy efficiency mode is selected, the system is dynamically involved in adjustment of CPU frequency according to a load. Meanwhile, different performance and energy consumption scenes (that is, operating modes of the processor) may set different BMC fan heat dissipation control strategies (that is, the heat dissipation strategies of the heat dissipation device) accordingly. When the high-performance calculation mode is selected, a higher fan speed is provided, and a corresponding fan speed regulation strategy (namely, fan speed controlling strategy) is a high-performance mode. When the performance and energy consumption scene selects the energy-saving mode, a lower fan speed is provided, and a corresponding fan speed regulation strategy is a low-noise mode. When the performance and energy consumption scene selects the energy efficiency mode, the fan speed is dynamically adjusted, and a corresponding fan speed regulation strategy is the energy-saving mode (that is, the energy efficiency strategy).

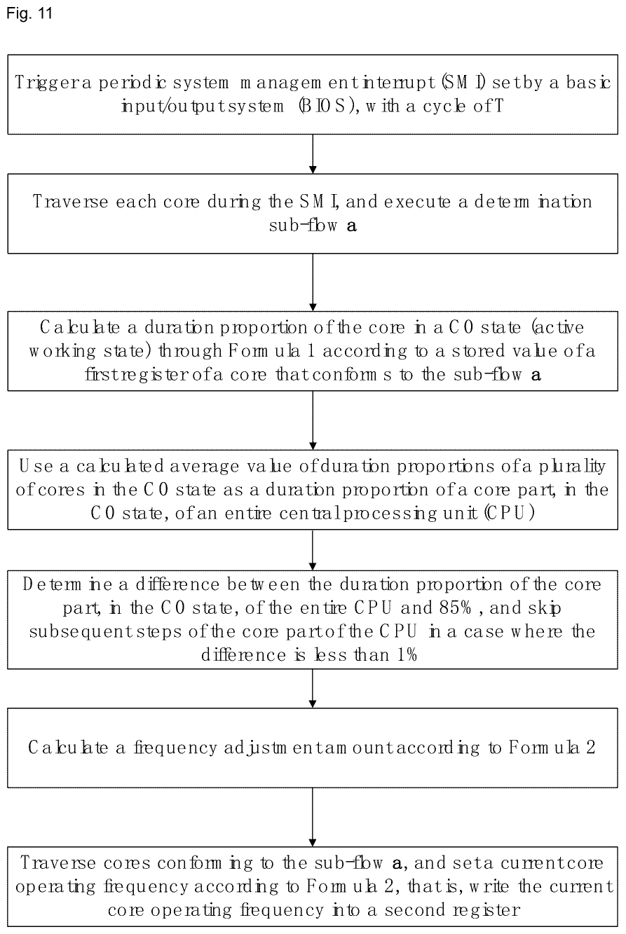

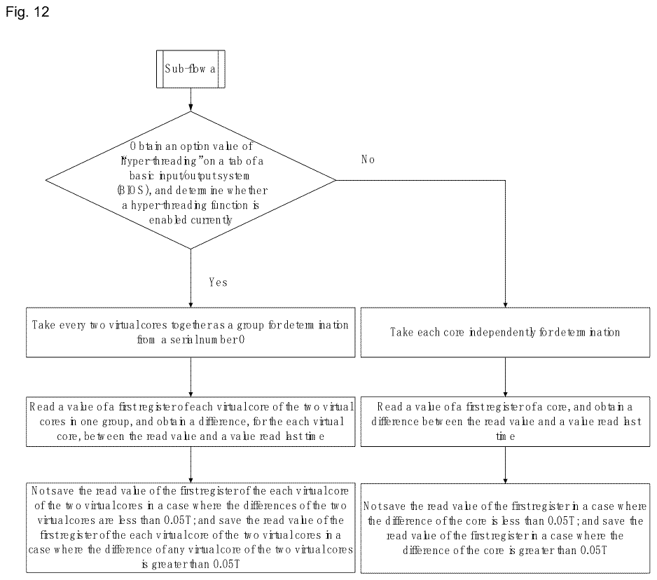

In some examples, when the energy efficiency mode is selected, a “dynamic frequency modulation” function (that is, the adjustment function) may be enabled in linkage, which is not limitative. The “dynamic frequency modulation” function is mainly enabled by triggering periodic system management interrupt (SMI) set by the BIOS. FIG. 11 is a first flowchart of a dynamic energy efficiency management method for a server according to an example of the present disclosure. As shown in FIG. 11, the BIOS (that is, the control system), as a first program that operates when the server is booted, presets periodic SMI, and a triggering cycle of the SMI is T. The interrupt may be triggered when server time reaches a preset triggering point. The interrupt, like a signal, indicates that the BIOS of the control system begins to perform comprehensive checking once on an operating state of the CPU. After entering an SMI processing program, the system may traverse each CPU core sequentially. In the process, an operation of a determination sub-flow a may be executed. FIG. 12 is a flowchart of the determination sub-flow a according to an example of the present disclosure. As shown in FIG. 12, a value of a first register of a virtual core or a core may be read and the value may be compared with a value read last time of a first register to determine whether a core (that is, a core device) needs to adjust the operating frequency in a current cycle, which is not limitative. The first register herein may be, but is not limited to, MSR 0xE8, that is, a register with a model specific register address 0xE8, which is referred to as IA32_APERF in the processor. The register is mainly used for performance monitoring, and records a quantity of clock cycles spent by the processor during instruction execution in a C0 state (that is, an active working state). Whether the core needs frequency modulation may be determined by comparing a difference between a value of the first register read currently and a value of the register read last time with 0.05T, which is not limitative. The present disclosure may include the operation of determining whether the core needs frequency modulation by comparing a ratio (that is, the state parameter) of a difference between a value of the first register read currently and a value of the register read last time to a cycle T with 0.05 (that is, the first parameter threshold).

In some examples, as shown in FIG. 11, the BIOS may further determine a core that conforms to the sub-flow a after the sub-flow a is executed, which is not limitative. For the cores, the BIOS may read a value of MSR 0xE8 corresponding to a logic core. A value of the register means a quantity of clock cycles passed by a current logic core in the C0 state. According to Formula 1: CoreC0Residency=(APERFAfter−APERFBefore)/T, a difference of the register between two times of entering the SMI is divided by SMI cycle time, such that a C0Residency value (that is, the state parameter) of each core whose frequency is to be adjusted can be obtained. The value reflects a time proportion of the logic core in the active working state. Then, the BIOS may collect C0Residency values of all cores whose frequencies are to be adjusted, and calculate an average value (that is, the first state parameter). The average value represents C0Residency of an entire CPU core part and is an important indicator to measure an overall load of a CPU. Based on the calculated average value of C0Residency, the BIOS may compare the average value with 85% (the second parameter threshold). The threshold of 85% is an empirical setting, which represents a high level of the CPU load. If C0Residency approaches or exceeds 85%, it indicates that the CPU is a high-load operating state, and a frequency may be possibly increased to satisfy work requirements. On the contrary, if C0Residency is much lower than 85%, a frequency may be reduced appropriately to save energy. According to a comparison result, the control system may calculate the frequency adjustment amount and an adjusted frequency value according to preset Formula 2: Freqexpectation=Freqcurrent+(100×C0Residency−85)×0.1, Freqmax≥Freqexpectation≥Freqmin. The Formula 2 comprehensively considers a difference between C0Residency and a threshold, a performance requirement of the server, an energy-saving target and other factors to ensure that an adjusted frequency can not only satisfy workload, but also implement rational use of energy. Finally, the control system may traverse cores whose frequencies are to be adjusted again, and write an adjusted frequency value into a second register (for instance, an MSR 0x199 register) corresponding to each logic core according to a calculation result of the Formula 2. MSR 0x199 is a special register configured to control a core frequency. By modifying a value of the register, the control system can directly change the core operating frequency.

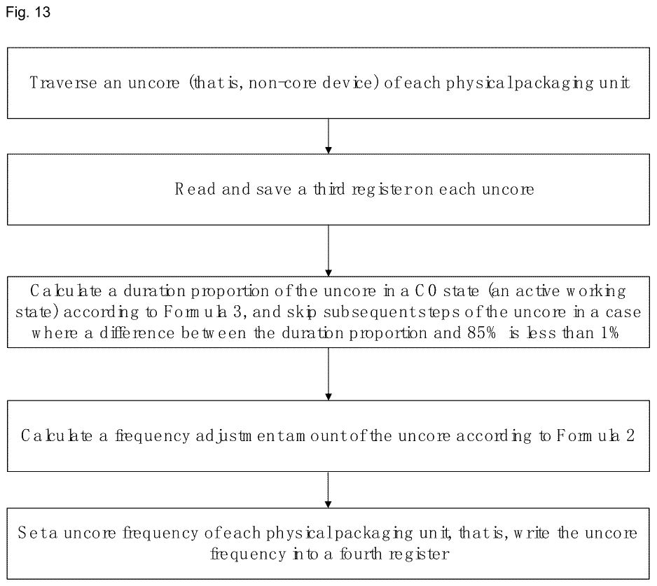

FIG. 13 is a second flowchart of a dynamic energy efficiency management method for a server according to an example of the present disclosure. As shown in FIG. 13, there is a similar operation logic for an uncore (that is, non-core device) part of the CPU, and the control system may enable an operation of traversing an uncore of each package (that is, physical packaging unit). In one multi-core processor, the package is a physically packaged unit, and includes a plurality of cores and uncore parts. The uncore covers components such as a cache, a memory controller, and a bus interface, which play a key role in data interaction and cooperation between the processor and other hardware devices. The control system may check the uncore in each package sequentially to prepare for subsequent performance evaluation and adjustment. Then, when each uncore is traversed, the system may read a third register (for instance, an MSR 0x3F9 register) on the uncore. A value in the register represents C6 residency of the uncore in the package (that is, a time proportion of the uncore in an inactive state). According to Formula 3: UncoreC0Residency=1−(UncoreC6ResidencyAfter−UncoreC6ResidencyBefore)/T, C0Residency (a C0 state duration proportion, that is, the second state parameter) of the uncore is calculated through values (UncoreC6Residency After and UncoreC6ResidencyBefore) of the third register read when the SMI is entered twice. A difference between the C0Residency and 85% (that is, the fourth parameter threshold) is compared with 1% (that is, the fifth parameter threshold). When the difference between the C0Residency and 85% is greater than 1%, an expected uncore frequency of the uncore is calculated according to the Formula 2. Finally, a calculated frequency value is written into a fourth register (for instance, an MSR 0x620 register), which may make a set frequency effective.

In some examples, the control system may map the set frequencies to an expected fan speed after frequencies of the core and the uncore are set, which is not limitative. A pulse width modulation (PWM) duty cycle (Duty) during actual regulation is configured to represent the fan speed. Maximum and minimum core frequencies and uncore frequencies currently supported by the CPU may be obtained, granularity (that is, the above 0.1 GHz) may be adjusted according to differences and an obtained minimum frequency of the currently used CPU, and a quantity k of parts (that is, a target quantity) divided at thinnest adjustment intervals between a maximum frequency and a minimum frequency may be calculated, such that a mapping relationship between a frequency adjustment interval and a fan duty may be established, which is not limitative. A minimum fan duty is set to 10%, because certain heat dissipation is required even when the server is completely out of work. The setting of the fan speed may be executed through one periodic function invoked by a platform runtime mechanism (PRM), which is not limitative. Thus, too long SMI time due to continuous execution of too many tasks during SMI can be avoided, and system performance is influenced. After the core and uncore frequencies of the system are calculated and set, the program may transfer the two frequency values to a fan speed setting function, and the fan speed setting function may complete regulation of the fan speed by sending an IPMI command to the BMC. The periodic function invoked by the platform runtime mechanism (PRM) may be, but is not limited to, a BIOS code operating under an operating system (OS). A process of frequency setting and requirement determination may be not set in a PRM function for processing, which is not limitative. Because a function invoked by the PRM is one single-threaded task invoked under the OS, MSR registers corresponding to all threads cannot be read and written under a single thread.

Through the above contents, extra power consumption waste caused by excessive CPU frequency under a low load can be effectively avoided through determination of C0Residency, and the fan speed can be adjusted in real time according to a dynamic load. Further, an energy efficiency ratio of the entire server is improved, a closed loop of load perception, strategy calculation and hardware execution is implemented, and three-dimensional balance of performance, power consumption and temperature is implemented. Its core value lies in maintaining the active working state of the core and the non-core of the CPU in an efficient range of about 85%, and meanwhile, reducing operational and maintenance cost.

In some examples, after the frequency adjustment amount corresponding to the currently traversed non-core device is calculated according to the third difference and the unit frequency, the method further includes the following steps: a function adjustment direction is determined according to a frequency adjustment direction of the frequency adjustment amount for a non-core frequency of the processor, and a function adjustment amount is determined according to the frequency adjustment amount, where the function adjustment direction is an adjustment direction of an operating level of a device function of the non-core device, the function adjustment amount is an adjustment amount of the operating level of the device function of the non-core device, and the higher the operating level, the greater energy consumption of the non-core device; and the operating level of the device function of the non-core device is adjusted according to the function adjustment direction and the function adjustment amount.

In some examples, after the frequency of the core device and the frequency of the non-core device of the processor are adjusted, the operating level of the device function of the non-core device may be adjusted according to frequency adjustment trends of the core device and the non-core device, so as to further achieve energy-saving, which is not limitative.

Through the above contents, the frequency adjustment direction and the frequency adjustment amount are associated with the operating level of the non-core device, such that performance and power consumption can be weighed and balanced in a more intelligent manner, and an energy efficiency ratio can be improved. In a low-load scene, the operating level of the non-core device is reduced, and power consumption is reduced. In a high-load scene, the operating level needs to be improved appropriately to ensure that a performance requirement is satisfied.

In some examples, the step that the operating frequency of the processor is adjusted according to the processor information corresponding to the target state includes the following steps: an expected frequency of each device in the processor is determined according to the processor information corresponding to the target state; an operating state of the processor at the expected frequency of each device is predicted; a current priority parameter of the each device is adjusted according to a change rate between the processor information of the each device and reference processor information in a case where the operating state fails to satisfy an operating condition of the processor, and a target priority parameter is obtained, where the reference processor information is detected in a last execution cycle of the adjustment function, and the priority parameter is configured to indicate an importance level of a performance requirement of the corresponding device to the processor; and an operating frequency of the each device is adjusted according to the target priority parameter and the operating condition.

In some examples, each device in the processor may include, but is not limited to, each core device and each non-core device.

In some examples, the step that the operating state of the processor at the expected frequency of each device is predicted may include, but is not limited to, the step that a temperature of the processor when each device of the processor operates at the corresponding expected frequency is predicted.

In some examples, the condition that the operating state fails to satisfy the operating condition of the processor may include, but is not limited to, the condition that the temperature of the processor is greater than or equal to a highest acceptable temperature of the processor during operation when all devices of the processor operate at their respective expected frequencies. In this case, if the operation frequencies of all the devices are directly set as their respective expected frequencies, the processor may fail to operate normally, resulting in direct and automatic frequency reduction of the processor. In order to avoid this case, further operations on the expected frequencies are needed.

In some examples, the priority parameter may be configured to indicate the importance of the performance requirement of the corresponding device to the processor, that is, may be configured to indicate urgency of the performance requirement of the corresponding device, which is not limitative.

In some examples, the present disclosure may first satisfy a frequency modulation requirement of a device having a higher target priority parameter, and ensure a frequency modulation requirement of a device having a lower target priority parameter as much as possible while ensuring that the operating condition is satisfied, which is not limitative.

Through the above contents, the change rate between the processor information of each device and reference processor information in a last adjustment cycle is calculated, and the priority parameter of each device is dynamically adjusted based on the change rate. This mechanism can quickly identify a changing trend of the performance requirement, give priority to satisfying a requirement of a key device, ensure that most important tasks or services get sufficient performance support, and meanwhile, reduce attention to secondary devices, so as to achieve effective allocation of resources.

In some examples, the steps that a current priority parameter of the each device is adjusted according to the change rate between the processor information of the each device and the reference processor information, and a target priority parameter is obtained include the following steps: a difference between the processor information of the each device and the reference processor information is determined as the change rate; the priority parameter of a current device is increased in a case where the change rate is greater than a first threshold, and the target priority parameter is obtained; the priority parameter of the current device is decreased in a case where the change rate is less than the first threshold and greater than a second threshold, and the target priority parameter is obtained; and the priority parameter of the current device is determined as a minimum priority in a case where the change rate is less than the second threshold, and the target priority parameter is obtained.

In some examples, each device of the processor may have an identical initial priority parameter, which is not limitative. Or, identical initial priority parameters may be set for each core device and identical initial priority parameters may be set for each non-core device as required. The initial priority parameters of the core devices are different from those of the non-core devices.

In some examples, the present disclosure may determine that more fluctuations of busyness of a current device indicate a more urgent frequency modulation requirement in a case where the change rate is greater than or equal to the first threshold, which is not limitative. Thus, a priority parameter of the current device is increased. The present disclosure may determine that fewer fluctuations of busyness of a current device indicate a less urgent frequency modulation requirement in a case where the change rate is less than the first threshold and greater than or equal to the second threshold, which is not limitative. Thus, a priority parameter of the current device is decreased. The present disclosure may determine that a performance requirement of the current device has lower importance to the processor in a case where the change rate is less than the second threshold, which is not limitative. Thus, a priority parameter of the current device is determined as the minimum priority.

In some examples, the first threshold may be greater than 0, which is not limitative.

In some examples, the second threshold may be greater than 0 or less than 0, which is not limitative.

In some examples, the step that an operating frequency of each device is adjusted according to the target priority parameter and the operating condition includes the following steps: a target device having the expected frequency satisfying the operating condition is selected from other devices of the processor other than a device having the minimum priority according to the target priority parameter in descending order; an operating frequency of the target device is adjusted to the expected frequency corresponding to the target device; and an operating frequency of the device having the minimum priority is reduced.

In some examples, an operating frequency of a device having a minimum priority level may be directly reduced to provide a larger frequency adjustment space for a device having a performance requirement with higher importance to the processor, which is not limitative.

In some examples, in the dynamic energy efficiency management method for a server as shown in FIG. 11, FIG. 12 and FIG. 13, in some working scenes, both the core and the uncore have very high frequency requirements. (It should be noted that the requirements herein are requirements for which software under the operating system applies to a kernel or a CPU, so the requirements may be real or false (that is, services having lower actual performance requirements apply for greater performance)). However, thermal design power (TDP) of one CPU is fixed, and fails to satisfy both an extreme core frequency and an extreme uncore frequency. In this case, an adjustment solution at the bottom of the CPU, that is, frequency reduction, is generally triggered because of overheating caused by thermal accumulation. In this case, the CPU may directly reduce the frequency to ensure that current power consumption does not exceed the TDP and the temperature of the processor does not exceed a threshold temperature, thus preventing the CPU from being burned by high temperature. In this case, the frequency is rigidly reduced, and is actually more unable to satisfy actual service needs. Frequency fluctuations may make service performance worse, which can neither satisfy a performance requirement of a working scene nor bring a high energy efficiency ratio of an overall unit.

In some examples, in view of the above considerations, the BIOS may read and write a series of MSR registers in the SMI processing program to obtain a series of CPU feature values, such as unhalted processor time (CPU_CLK_UNHALTED), non-core ultra path interconnect (UPI) link use (UNC_UPI), and input/output measure (IO_METRIC), which is not limitative. The feature values can reflect not only the usage ratio of the processor, but also a UPI link usage ratio, an IO access proportion, a memory reading and writing proportion, etc. By synthesizing the above feature values, the frequency modulation requirements of the core devices and the non-core devices of the processor are comprehensively determined.

In some examples, in the series of feature values, some feature values can represent usage ratios of physical links of some devices, such as a usage ratio of UPI, a usage ratio of a peripheral component interconnect express (PCIe) device, and a usage ratio of a memory. If actual data transmission on the physical links continues to be 0, the corresponding devices are informed of reduction of an energy consumption level during SMI processing. For the UPI, a control unit is informed of downgrading of a UPI link from L0 to L1 to enter a more power-saving state, so as to achieve a higher energy efficiency ratio.

In some examples, in view of the above considerations, the present disclosure further proposes a preemptive core and uncore frequency regulation strategy. By combining the dynamic energy efficiency management method for a server, after respective C0Residency of a current core and a current uncore is obtained, C0Residency obtained at a current moment of entering interrupt is subtracted from C0Residency obtained at a last moment of entering interrupt, and the difference is divided by the C0Residency obtained at the last moment of entering interrupt, such that a change rate of each C0Residency is obtained. A positive threshold (that is, the first threshold) and a negative threshold (that is, the second threshold) are set for the change rate (the change rate may be positive or negative). The positive threshold and the negative threshold are adjusted according to experiments and experiences. In the current SMI, when the change rate exceeds the positive threshold, a new performance requirement change is determined, and the core or the uncore with the change rate greater than or equal to the positive threshold increases a weight by 1 accordingly. When the change rate is less than the positive threshold and greater than the negative threshold, the core or the uncore decreases a weight by 1. When the change rate is less than the negative threshold, a frequency of the corresponding core or uncore is directly reduced. After all the change rates and weights are calculated, during the current SMI processing, a device having a highest weight is considered to have a most important performance requirement, and a frequency of the device needs to be adjusted first. If power consumption of operation at the expected frequency is about to reach the TDP, a frequency of a device having an unimportant performance requirement needs to be reduced, thus ensuring the frequency of the device having the important performance requirement.

In some examples, the change rate and the weight in a periodic SMI processing function may be saved, and a change situation of the change rate in a periodic function invoked by the PRM may be determined, which is not limitative. If the change rate remains 0 continuously and it is determined that the current working scene is stable, a count value of a timer triggering SMI may be adjusted in the periodic function of the PRM to increase the count value. Thus, an SMI cycle is lengthened accordingly, a frequency at which SMI is entered is reduced, and performance is prevented from being influenced due to too frequent entry into SMI. In addition, one time threshold is set. When no SMI is entered beyond the time threshold, SMI is forced to be entered once to determine a current requirement change.

From the description of the embodiments, those skilled in the art can clearly understand that the methods according to the examples can be implemented through software plus a necessary general-purpose hardware platform, or through hardware. In most cases, the former is a better embodiment.

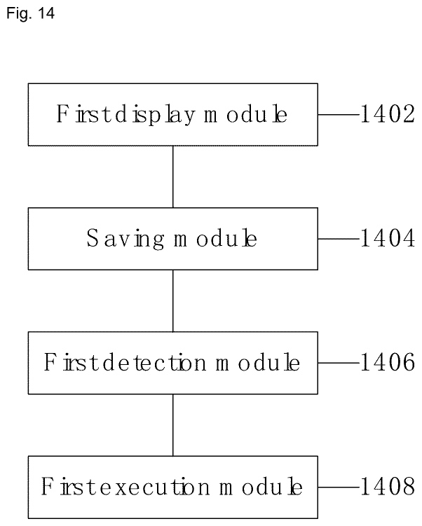

An example of the present disclosure further provides an apparatus for executing a system function. FIG. 14 is a block diagram of a structure for executing a system function according to an example of the present disclosure. As shown in FIG. 14, the apparatus includes:
a first display module 1402, configured to display a first configuration interface of a control system of a server, where a first tab is displayed on the first configuration interface, and the first tab is configured to configure an operating mode configuration option of a processor of the server;
a saving module 1404, configured to save an option value of the first tab on the first configuration interface in response to a confirmation operation triggered on the first configuration interface;
a first detection module 1406, configured to detect a configuration state of the option value of the first tab in a startup process of the server; and
a first execution module 1408, configured to execute an adjustment function through the control system in an operating process of the processor in a case where the configuration state is detected as a target state, where the adjustment function is configured to adjust an operating frequency of the processor.

Through the apparatus, the first configuration interface of the control system of the server is displayed to provide a selection of the operating mode configuration option of the processor of the server; the option value of the first tab on the first configuration interface is saved in response to the confirmation operation triggered on the first configuration interface; the configuration state of the option value of the first tab is detected in the startup process of the server; and then the adjustment function configured to adjust the operating frequency of the processor is executed through the control system in the operating process of the processor in a case where the configuration state is detected as the target state. That is, the operating mode of the processor of the server can be flexibly selected through the first configuration interface, the operating frequency of the processor can be flexibly adjusted when the processor operates in the target state, and the operating flexibility of the processor of the server can be effectively improved. Thus, a technical problem of poor operating flexibility of a processor of a server in the related art can be solved, and a technical effect of improving the operating flexibility of the processor of the server can be achieved.

In some examples, the first display module includes a first display unit, configured to display a first sub-tab and a second sub-tab on the first configuration interface. The first sub-tab is configured to configure the operating mode configuration option. The second sub-tab is configured to configure a configuration option of the adjustment function to be enabled or disabled. The first tab includes the first sub-tab and the second sub-tab.

In some examples, the first display module further includes a second display unit, configured to display at least one third sub-tab on the first configuration interface in a case where an option value of the second sub-tab is an enabling option. The enabling option is configured to instruct the adjustment function to be enabled. The at least one third sub-tab is configured to configure a configuration option of at least one function parameter used in the adjustment function.

In some examples, the second display unit is further configured to display a parameter threshold tab and/or a function cycle tab on the first configuration interface. The parameter threshold tab is configured to configure a configuration option of a parameter threshold used in the adjustment function. The function cycle tab is configured to configure a configuration option of an execution cycle of the adjustment function. The at least one third sub-tab includes the parameter threshold tab and/or the function cycle tab.

In some examples, the first display unit is further configured to display, on the first configuration interface, an option value of the first sub-tab as an energy efficiency mode option, and an option value of the second sub-tab as an enabling option, where the energy efficiency mode option is configured to configure an operating mode of the processor of the server as an energy efficiency mode, the energy efficiency mode is configured to control the processor to balance an energy efficiency of the processor in the operating process, and the enabling option is configured to instruct the adjustment function to be enabled; and display, on the first configuration interface, the option value of the first sub-tab as another mode option, and the option value of the second sub-tab as a disabling option. The another mode option is configured to configure an operating mode of the processor of the server as a mode other than the energy efficiency mode. The disabling option is configured to instruct the adjustment function to be disabled.

In some examples, the first detection module includes a first detection unit, configured to detect an option value of a second sub-tab displayed on the first configuration interface, where the first tab includes a first sub-tab and the second sub-tab, the first sub-tab is configured to configure the operating mode configuration option, and the second sub-tab is configured to configure a configuration option of the adjustment function to be enabled or disabled; and a first determination unit, configured to determine that the configuration state is detected as the target state in a case where the option value of the second sub-tab is an enabling option.

In some examples, the apparatus for executing a system function further includes a second display module, configured to display a second configuration interface of a controller of the server, where a second tab is displayed on the second configuration interface, and the second tab is configured to configure the operating mode configuration option for the control system; a first sending module, configured to send, by the controller, an option value of the second tab on the second configuration interface to the control system in response to a confirmation operation triggered on the second configuration interface; and a first configuration module, configured to configure the operating mode configuration option by the control system according to the option value of the second tab.

In some examples, the first configuration module includes a first configuration unit, configured to configure, by the control system, an operating mode of the processor as the option value of the second tab; a second configuration unit, configured to configure a configuration option of the adjustment function to be enabled in a case where the option value of the second tab is an energy efficiency mode option, where the energy efficiency mode option is configured to configure the operating mode of the processor of the server as an energy efficiency mode, and the energy efficiency mode is configured to control the processor to balance an energy efficiency of the processor in the operating process; and a third configuration unit, configured to configure the configuration option of the adjustment function to be disabled in a case where the option value of the second tab is another mode option. The another mode option is configured to configure the operating mode of the processor of the server as a mode other than the energy efficiency mode.

In some examples, the apparatus for executing a system function further includes a second configuration module, configured to configure, by the control system, a configuration option of at least one function parameter used in the adjustment function as a default parameter corresponding to each of the at least one function parameter in a case where the option value of the second tab is the energy efficiency mode option. The at least one function parameter includes a parameter threshold used in the adjustment function, and/or an execution cycle of the adjustment function.

In some examples, the apparatus for executing a system function further includes a third display module, configured to display a third configuration interface of a controller of the server, where a third tab is displayed on the third configuration interface, and the third tab is configured to configure a heat dissipation strategy configuration option of a heat dissipation device of the server; a second detection module, configured to detect, by the controller, an option value of the third tab in response to a confirmation operation triggered on the third configuration interface; a second sending module, configured to send, by the controller, a first configuration instruction to the control system in a case where the option value of the third tab is an energy efficiency strategy option, where the first configuration instruction is configured to instruct the control system to configure an operating mode of the processor as an energy efficiency mode and to configure a configuration option of the adjustment function to be enabled, the energy efficiency mode is configured to control the processor to balance an energy efficiency of the processor in the operating process, the energy efficiency strategy option is configured to configure a heat dissipation strategy of the heat dissipation device as an energy efficiency strategy, and the energy efficiency strategy is configured to instruct a heat dissipation parameter of the heat dissipation device to be adjusted according to the operating frequency of the processor in the operating process; and a second execution module, configured to execute the first configuration instruction by the control system in the startup process of the server, and execute the adjustment function through the control system in the operating process of the processor.

In some examples, the apparatus for executing a system function further includes a third sending module, configured to send, by the control system, a second configuration instruction to a controller of the server in a case where the configuration state is detected as the target state, where the second configuration instruction is configured to instruct the controller to configure a heat dissipation strategy of a heat dissipation device of the server as an energy efficiency strategy, and the energy efficiency strategy is configured to instruct a heat dissipation parameter of the heat dissipation device to be controlled according to the operating frequency of the processor in the operating process; and a third execution module, configured to execute the second configuration instruction by the controller, and control the heat dissipation parameter of the heat dissipation device according to the operating frequency of the processor in the operating process.

In some examples, the apparatus for executing a system function further includes a control module, configured to control a heat dissipation parameter of a heat dissipation device of the server by the control system according to the operating frequency of the processor in the operating process.

In some examples, the control module includes a generation unit, configured to generate a target heat dissipation parameter by the control system according to the operating frequency of the processor in the operating process; a sending unit, configured to send, by the control system, the target heat dissipation parameter to a controller of the server; and a first control unit, configured to control operation of the heat dissipation device by the controller based on the target heat dissipation parameter.

In some examples, the third execution module or the control module includes a searching unit, configured to search processor frequencies and heat dissipation parameters having a correspondence for a current heat dissipation parameter corresponding to a current processor frequency of the processor, where the processor frequencies and the heat dissipation parameters having the correspondence are established according to a maximum processor frequency and a minimum processor frequency of the processor; and a second control unit, configured to control an operation of the heat dissipation device based on the current heat dissipation parameter.

In some examples, the third execution module or the control module further includes a calculation unit, configured to calculate a target quantity according to the maximum processor frequency, the minimum processor frequency and a unit frequency, where the unit frequency is configured to indicate a minimum frequency value by which the processor is allowed to be adjusted; a division unit, configured to divide, based on the target quantity, processor frequencies between the minimum processor frequency and the maximum processor frequency into a plurality of processor frequencies according to the unit frequency, and divide heat dissipation parameters between a minimum heat dissipation parameter and a maximum heat dissipation parameter into a plurality of heat dissipation parameters according to the target quantity, where a total frequency quantity of the plurality of processor frequencies, the minimum processor frequency and the maximum processor frequency is the target quantity, and a total parameter quantity of the plurality of heat dissipation parameters, the minimum heat dissipation parameter and the maximum heat dissipation parameter is the target quantity; and an establishment unit, configured to establish a correspondence between the maximum processor frequency and the maximum heat dissipation parameter, a correspondence between the minimum processor frequency and the minimum heat dissipation parameter, and a one-to-one correspondence between the plurality of processor frequencies and the plurality of heat dissipation parameters, to obtain the processor frequencies and the heat dissipation parameters having the correspondence. The larger the processor frequency the larger the corresponding heat dissipation parameter.

In some examples, the first execution module includes an adjustment unit, configured to adjust the operating frequency of the processor according to processor information corresponding to the target state through the control system in the operating process of the processor.

In some examples, the adjustment unit is further configured to adjust a core operating frequency of the processor according to first processor information corresponding to a core device, and adjust a non-core operating frequency of the processor according to second processor information corresponding to a non-core device. The processor information includes the first processor information and the second processor information. The processor includes the core device and the non-core device. The operating frequency of the processor includes the core operating frequency and the non-core operating frequency.

In some examples, the adjustment unit is further configured to detect a first state parameter of the core device, where the first processor information includes the first state parameter, and the first state parameter is configured to indicate a time proportion of the core device operating in an active working state; calculate a target core operating frequency according to the first state parameter and a current core operating frequency of the processor; and adjust the core operating frequency of the processor from the current core operating frequency to the target core operating frequency.

In some examples, the adjustment unit is further configured to obtain a hyper-threading configuration option of the control system, where the hyper-threading configuration option is configured to indicate whether to enable a hyper-threading function of the control system; determine a plurality of virtual cores in the processor as one core device in a case where the hyper-threading configuration option is detected to be configured to indicate that the hyper-threading function is enabled, to obtain one or more core devices; determine each virtual core in the processor as one core device in a case where the hyper-threading configuration option is detected to be configured to indicate that the hyper-threading function is disabled, to obtain one or more core devices; traverse each of the one or more core devices in the processor; detect a state parameter corresponding to each of the one or more core devices, where the state parameter corresponding to each of the one or more core devices is configured to indicate a time proportion of the corresponding core device operating in an active working state; determine at least one, having the corresponding state parameter greater than or equal to a first parameter threshold, of the one or more core devices as one or more target core devices; and determine an average value of one or more state parameters of the one or more target core devices as the first state parameter.

In some examples, the adjustment unit is further configured to calculate a first difference between the first state parameter and a second parameter threshold; calculate a frequency adjustment amount corresponding to each of the one or more target core devices according to a second difference between the state parameter of each of the one or more target core devices and the second parameter threshold and a unit frequency in a case where the first difference is greater than or equal to a third parameter threshold, where the unit frequency is configured to indicate a minimum frequency value by which the processor is allowed to be adjusted; and determine a sum of a current core operating frequency corresponding to each of the one or more target core devices and the frequency adjustment amount corresponding to each of the one or more target core devices as the target core operating frequency corresponding to each of the one or more target core devices.

In some examples, the adjustment unit is further configured to detect a second state parameter of the non-core device, where the second processor information includes the second state parameter, and the second state parameter is configured to indicate a time proportion of the non-core device operating in an active working state; calculate a target non-core operating frequency according to the second state parameter and a current non-core operating frequency of the processor; and adjust the non-core operating frequency of the processor from the current non-core operating frequency to the target non-core operating frequency.

In some examples, the adjustment unit is further configured to traverse each of the non-core devices; calculate a third difference between the second state parameter of the currently traversed non-core device and a fourth parameter threshold; calculate a frequency adjustment amount corresponding to the currently traversed non-core device according to the third difference and a unit frequency in a case where the third difference is greater than or equal to a fifth parameter threshold, where the unit frequency is configured to indicate a minimum frequency value by which the processor is allowed to be adjusted; and determine a sum of a current core operating frequency corresponding to the currently traversed non-core device and the frequency adjustment amount corresponding to the currently traversed non-core device as the target non-core operating frequency corresponding to the currently traversed non-core device.

In some examples, after calculating the frequency adjustment amount corresponding to the currently traversed non-core device according to the third difference and the unit frequency, the adjustment unit is further configured to determine a function adjustment direction according to a frequency adjustment direction of the frequency adjustment amount for a non-core frequency of the processor, and determine a function adjustment amount according to the frequency adjustment amount, where the function adjustment direction is an adjustment direction of an operating level of a device function of the non-core device, the function adjustment amount is an adjustment amount of the operating level of the device function of the non-core device, and the higher the operating level, the greater energy consumption of the non-core device; and adjust the operating level of the device function of the non-core device according to the function adjustment direction and the function adjustment amount.

In some examples, the adjustment unit is further configured to determine an expected frequency of each device in the processor according to the processor information corresponding to the target state; predict an operating state of the processor at the expected frequency of the each device; adjust a current priority parameter of the each device according to a change rate between the processor information of the each device and reference processor information in a case where the operating state fails to satisfy an operating condition of the processor, to obtain a target priority parameter, where the reference processor information is detected in a last execution cycle of the adjustment function, and the priority parameter is configured to indicate an importance level of a performance requirement of the corresponding device to the processor; and adjust an operating frequency of the each device according to the target priority parameter and the operating condition.

In some examples, the adjustment unit is further configured to determine a difference between the processor information of the each device and the reference processor information as the change rate; increase the priority parameter of a current device in a case where the change rate is greater than a first threshold, to obtain the target priority parameter; decrease the priority parameter of the current device in a case where the change rate is less than the first threshold and greater than a second threshold, to obtain the target priority parameter; and determine the priority parameter of the current device as a minimum priority in a case where the change rate is less than the second threshold, to obtain the target priority parameter.

In some examples, the adjustment unit is further configured to select a target device having the expected frequency satisfying the operating condition from other devices of the processor other than a device having the minimum priority according to the target priority parameter in descending order; adjust an operating frequency of the target device to the expected frequency corresponding to the target device; and reduce an operating frequency of the device having the minimum priority.

Reference may be made to related description of the examples corresponding to the method for executing a system function for description of features in the examples corresponding to the apparatus for executing a system function, which will not be repeated herein.

An example of the present disclosure further provides an electronic device. The electronic device includes a memory and a processor. The memory stores a computer program. The processor is configured to operate the computer program so as to execute steps of any one of the examples of the method for executing a system function.

An example of the present disclosure further provides a non-volatile readable storage medium. The non-volatile readable storage medium stores a computer program. The computer program is configured to execute steps of any one of the examples of the method for executing a system function at runtime.

In one illustrative example, the non-volatile readable storage medium may include, but is not limited to, a universal serial bus (USB) flash disk, a read-only memory (ROM), a random access memory (RAM), a mobile hard disk, a magnetic disk, an optical disk, and various media capable of storing computer programs.

An example of the present disclosure further provides a computer program product. The computer program product includes a computer program. When the computer program is executed by a processor, steps of any one of the examples of the method for executing a system function are implemented.

An example of the present disclosure further provides another computer program product. The computer program product includes a non-volatile readable storage medium. The non-volatile readable storage medium stores a computer program. When the computer program is executed by a processor, steps of any one of the examples of the method for executing a system function are implemented.

Those skilled in the art may further realize that units and algorithm steps of various instances described with reference to the examples disclosed herein can be implemented by electronic hardware, computer software, or a combination of both. To clearly illustrate interchangeability of hardware and software, compositions and steps of the instances are generally described in terms of functionality in the description. Whether the functions are executed by hardware or software depends on specific applications and design constraints of the technical solution. Those skilled in the art may use different methods to achieve the described functions for each specific application, which should not be considered to fall beyond the scope of the present disclosure.

The method and apparatus for executing a system function, the electronic device, the non-volatile readable storage medium, and the computer program product according to the present disclosure are described in detail above. Specific instances are configured to illustrate principles and embodiments of the present disclosure herein. The description of the examples is only configured to help understand the method and its core concept of the present disclosure. It should be noted that those of ordinary skill in the art may make several improvements and modifications to the present disclosure without departing from the principles of the present disclosure, and these improvements and modifications fall within the protection scope of claims of the present disclosure.

1. A method for executing a system function, comprising:
displaying a first configuration interface of a control system of a server, wherein a first tab is displayed on the first configuration interface, and the first tab is configured to configure an operating mode configuration option of a processor of the server;
saving an option value of the first tab on the first configuration interface in response to a confirmation operation triggered on the first configuration interface;
detecting a configuration state of the option value of the first tab in a startup process of the server; and
executing an adjustment function through the control system in an operating process of the processor in a case where the configuration state is detected as a target state, wherein the adjustment function is configured to adjust an operating frequency of the processor;
wherein the executing an adjustment function through the control system in an operating process of the processor comprises:
adjusting the operating frequency of the processor according to processor information corresponding to the target state through the control system in the operating process of the processor;
wherein the adjusting the operating frequency of the processor according to processor information corresponding to the target state comprises:
determining an expected frequency of each device in the processor according to the processor information corresponding to the target state;
predicting an operating state of the processor at the expected frequency of the each device;
adjusting a current priority parameter of the each device according to a change rate between the processor information of the each device and reference processor information in a case where the operating state fails to satisfy an operating condition of the processor, to obtain a target priority parameter, wherein the reference processor information is detected in a last execution cycle of the adjustment function, and the priority parameter is configured to indicate an importance level of a performance requirement of the corresponding device to the processor; and
adjusting an operating frequency of the each device according to the target priority parameter and the operating condition.

2. The method for executing a system function according to claim 1, wherein the displaying a first configuration interface of a control system of a server comprises:
displaying a first sub-tab and a second sub-tab on the first configuration interface, wherein the first sub-tab is configured to configure the operating mode configuration option, the second sub-tab is configured to configure a configuration option of the adjustment function to be enabled or disabled, and the first tab comprises the first sub-tab and the second sub-tab.

3. The method for executing a system function according to claim 2, wherein the displaying a first configuration interface of a control system of a server further comprises:
displaying at least one third sub-tab on the first configuration interface in a case where an option value of the second sub-tab is an enabling option, wherein the enabling option is configured to instruct the adjustment function to be enabled, and the at least one third sub-tab is configured to configure a configuration option of at least one function parameter used in the adjustment function.

4. The method for executing a system function according to claim 3, wherein the displaying at least one third sub-tab on the first configuration interface comprises:
displaying a parameter threshold tab and/or a function cycle tab on the first configuration interface, wherein the parameter threshold tab is configured to configure a configuration option of a parameter threshold used in the adjustment function, the function cycle tab is configured to configure a configuration option of an execution cycle of the adjustment function, and the at least one third sub-tab comprises the parameter threshold tab and/or the function cycle tab.

5. The method for executing a system function according to claim 2, wherein the displaying a first sub-tab and a second sub-tab on the first configuration interface comprises one of the following steps:
displaying, on the first configuration interface, an option value of the first sub-tab as an energy efficiency mode option, and an option value of the second sub-tab as an enabling option, wherein the energy efficiency mode option is configured to configure an operating mode of the processor of the server as an energy efficiency mode, the energy efficiency mode is configured to control the processor to balance an energy efficiency of the processor in the operating process, and the enabling option is configured to instruct the adjustment function to be enabled; and
displaying, on the first configuration interface, the option value of the first sub-tab as another mode option, and the option value of the second sub-tab as a disabling option, wherein the another mode option is configured to configure an operating mode of the processor of the server as a mode other than the energy efficiency mode, and the disabling option is configured to instruct the adjustment function to be disabled.

6. The method for executing a system function according to claim 1, wherein the detecting a configuration state of the option value of the first tab comprises:
detecting an option value of a second sub-tab displayed on the first configuration interface, wherein the first tab comprises a first sub-tab and the second sub-tab, the first sub-tab is configured to configure the operating mode configuration option, and the second sub-tab is configured to configure a configuration option of the adjustment function to be enabled or disabled; and
determining that the configuration state is detected as the target state in a case where the option value of the second sub-tab is an enabling option.

7. The method for executing a system function according to claim 1, wherein before the detecting a configuration state of the option value of the first tab in a startup process of the server, the method further comprises:
displaying a second configuration interface of a controller of the server, wherein a second tab is displayed on the second configuration interface, and the second tab is configured to configure the operating mode configuration option for the control system;
sending, by the controller, an option value of the second tab on the second configuration interface to the control system in response to a confirmation operation triggered on the second configuration interface; and
configuring the operating mode configuration option by the control system according to the option value of the second tab.

8. The method for executing a system function according to claim 7, wherein the configuring the operating mode configuration option by the control system according to the option value of the second tab comprises:
configuring, by the control system, an operating mode of the processor as the option value of the second tab;
configuring a configuration option of the adjustment function to be enabled in a case where the option value of the second tab is an energy efficiency mode option, wherein the energy efficiency mode option is configured to configure the operating mode of the processor of the server as an energy efficiency mode, and the energy efficiency mode is configured to control the processor to balance an energy efficiency of the processor in the operating process; and
configuring the configuration option of the adjustment function to be disabled in a case where the option value of the second tab is another mode option, wherein the another mode option is configured to configure the operating mode of the processor of the server as a mode other than the energy efficiency mode.

9. The method for executing a system function according to claim 8, further comprising:
configuring, by the control system, a configuration option of at least one function parameter used in the adjustment function as a default parameter corresponding to each of the at least one function parameter in a case where the option value of the second tab is the energy efficiency mode option, wherein the at least one function parameter comprises a parameter threshold used in the adjustment function, and/or an execution cycle of the adjustment function.

10. The method for executing a system function according to claim 1, wherein before the detecting a configuration state of the option value of the first tab in a startup process of the server, the method further comprises:
displaying a third configuration interface of a controller of the server, wherein a third tab is displayed on the third configuration interface, and the third tab is configured to configure a heat dissipation strategy configuration option of a heat dissipation device of the server;
detecting, by the controller, an option value of the third tab in response to a confirmation operation triggered on the third configuration interface;
sending, by the controller, a first configuration instruction to the control system in a case where the option value of the third tab is an energy efficiency strategy option, wherein the first configuration instruction is configured to instruct the control system to configure an operating mode of the processor as an energy efficiency mode and to configure a configuration option of the adjustment function to be enabled, the energy efficiency mode is configured to control the processor to balance an energy efficiency of the processor in the operating process, the energy efficiency strategy option is configured to configure a heat dissipation strategy of the heat dissipation device as an energy efficiency strategy, and the energy efficiency strategy is configured to instruct a heat dissipation parameter of the heat dissipation device to be adjusted according to the operating frequency of the processor in the operating process; and
executing the first configuration instruction by the control system in the startup process of the server, and executing the adjustment function through the control system in the operating process of the processor.

11. The method for executing a system function according to claim 1, wherein after the detecting a configuration state of the option value of the first tab, the method further comprises:
sending, by the control system, a second configuration instruction to a controller of the server in a case where the configuration state is detected as the target state, wherein the second configuration instruction is configured to instruct the controller to configure a heat dissipation strategy of a heat dissipation device of the server as an energy efficiency strategy, and the energy efficiency strategy is configured to instruct a heat dissipation parameter of the heat dissipation device to be controlled according to the operating frequency of the processor in the operating process; and
executing the second configuration instruction by the controller, and controlling the heat dissipation parameter of the heat dissipation device according to the operating frequency of the processor in the operating process.

12. The method for executing a system function according to claim 1, wherein after the executing an adjustment function through the control system in an operating process of the processor, the method further comprises:
controlling a heat dissipation parameter of a heat dissipation device of the server by the control system according to the operating frequency of the processor in the operating process.

13. The method for executing a system function according to claim 12, wherein the controlling a heat dissipation parameter of a heat dissipation device of the server by the control system according to the operating frequency of the processor in the operating process comprises:
generating a target heat dissipation parameter by the control system according to the operating frequency of the processor in the operating process;
sending, by the control system, the target heat dissipation parameter to a controller of the server; and
controlling an operation of the heat dissipation device by the controller based on the target heat dissipation parameter.

14. The method for executing a system function according to claim 12, wherein the controlling the heat dissipation parameter of a heat dissipation device of the server according to the operating frequency of the processor in the operating process comprises:
searching processor frequencies and heat dissipation parameters having a correspondence for a current heat dissipation parameter corresponding to a current processor frequency of the processor, wherein the processor frequencies and the heat dissipation parameters having the correspondence are established according to a maximum processor frequency and a minimum processor frequency of the processor; and
controlling an operation of the heat dissipation device to operate based on the current heat dissipation parameter.

15-16. (canceled)

17. The method for executing a system function according to claim 1, wherein the adjusting the operating frequency of the processor according to processor information corresponding to the target state comprises:
adjusting a core operating frequency of the processor according to a first processor information corresponding to a core device, and adjusting a non-core operating frequency of the processor according to a second processor information corresponding to a non-core device, wherein the processor information comprises the first processor information and the second processor information, the processor comprises the core device and the non-core device, and the operating frequency of the processor comprises the core operating frequency and the non-core operating frequency.

18. The method for executing a system function according to claim 17, wherein the adjusting a core operating frequency of the processor according to first processor information corresponding to a core device comprises:
detecting a first state parameter of the core device, wherein the first processor information comprises the first state parameter, and the first state parameter is configured to indicate a time proportion of the core device operating in an active working state;
calculating a target core operating frequency according to the first state parameter and a current core operating frequency of the processor; and
adjusting the core operating frequency of the processor from the current core operating frequency to the target core operating frequency.

19-24. (canceled)

25. The method for executing a system function according to claim 1, wherein the adjusting a current priority parameter of the each device according to a change rate between the processor information of the each device and reference processor information, to obtain a target priority parameter comprises:
determining a difference between the processor information of the each device and the reference processor information as the change rate;
increasing the priority parameter of a current device in a case where the change rate is greater than a first threshold, to obtain the target priority parameter;
decreasing the priority parameter of the current device in a case where the change rate is less than the first threshold and greater than a second threshold, to obtain the target priority parameter; and
determining the priority parameter of the current device as a minimum priority in a case where the change rate is less than the second threshold, to obtain the target priority parameter.

26. The method for executing a system function according to claim 25, wherein the adjusting an operating frequency of each device according to the target priority parameter and the operating condition comprises:
selecting a target device having the expected frequency satisfying the operating condition from other devices of the processor other than a device having the minimum priority according to the target priority parameter in descending order;
adjusting an operating frequency of the target device to the expected frequency corresponding to the target device; and
reducing an operating frequency of the device having the minimum priority.

27. (canceled)

28. An electronic device, comprising:
a memory, configured to store a computer program; and
a processor, configured to implement steps of the method for executing a system function according to claim 1 in response to executing the computer program.

29. A non-transitory readable storage medium, storing a computer program, wherein when the computer program is executed by a processor, steps of the method for executing a system function according to claim 1.

30. (canceled)
